(19) United States
(12) Patent Application Publication
(10) Pub. No.: US 2025/0322653 A1
(43) Pub. Date: Oct. 16, 2025

(54) DETERMINING OCCUPANCY USING SENSOR FUSION FOR AUTONOMOUS SYSTEMS AND APPLICATIONS

(71) Applicant: NVIDIA Corporation, Santa Clara, CA (US)

(72) Inventors: Aman Jhunjhunwala, Toronto (CN); Jiahui Zhang, Shanghai (CN); Wongun Choi, Los Altos, CA (US); Sang Oh, San Jose, CA (US)

(21) Appl. No.: 18/634,425

(22) Filed: Apr. 12, 2024

(51) Int. Cl. G06V 10/80; G01S 13/56; G01S 13/86; G06V 10/82

(52) U.S. Cl. CPC G06V 10/806; G01S 13/56; G01S 13/862; G01S 13/867; G06V 10/82

(57) ABSTRACT

The present disclosure relates to performing sensor and/or temporal fusion for occupancy determinations in autonomous or semi-autonomous systems and applications. For example, ultrasonic data, image data, and RADAR data may be processed using one or more neural networks to generate output data corresponding to one or more objects in an area. During processing, a first feature dataset, a second feature dataset, and a third feature dataset may be extracted from the ultrasonic sensor data, the image data, and the RADAR data, respectively, and a combined feature dataset corresponding to the output data may be generated based at least on the first feature dataset, the second feature dataset and the third feature dataset. A machine may be caused to perform one or more operations based at least on the output data.

### BACKGROUND

Machines that perform autonomous and/or semi-autonomous navigation operations, which may be referred to herein as “ego-machines”, use perception systems to identify locations of objects and features in space, and in relation to the ego-machines. Such object identification is used to determine navigable areas (which may be referred to as “free-space”) for the ego-machines.

In some instances, object maps or other environmental representations that identify the locations of objects in relation to ego-machines may be generated. For example, these generated representations of the environment may include a birds-eye-view (BEV) perspective of an area surrounding an ego-machine (also referred to as a BEV map). The BEV map may indicate locations of static and/or dynamic objects that are proximate to the ego-machine and/or may indicate regions of the environment that may be navigable (e.g., free-space) or non-navigable by the ego-machine.

Some approaches for identifying objects for object map population may include using LiDAR or RADAR to identify locations of objects within an environment. For instance, RADAR data or LiDAR data, which may be represented using point clouds, may be processed in order to determine the locations of the objects within the environment. A heatmap, which may include a BEV map, may be generated that indicates the locations of the objects relative to the ego-machine. However, using LiDAR or RADAR alone may also generate less reliable maps based on noise and/or errors within the processing. For example, RADAR data may be unreliable at close distances, while generating such heatmaps using LiDAR may require increased compute and expense—e.g., as LiDAR data may be more compute intensive to process and LiDAR sensors may generally be more expensive than other sensor types (e.g., RADAR, camera, etc.).

Some other approaches may include using ultrasonic sensor data (“USS data”) to generate object maps. However, USS data may be less reliable as distances from the corresponding sensors increase. Further, USS data may not be reliable with respect to certain objects (e.g., wheel stoppers, ground locks, curbs, walls, thin poles, traffic cones, etc.), especially when these objects are at distance greater than three meters from the ego-machine.

### SUMMARY

According to one or more embodiments of the present disclosure, ultrasonic sensor data corresponding to an area may be obtained. Additionally, image data corresponding to the area and RADAR data corresponding to the area may be obtained. Using one or more neural networks, output data corresponding to one or more objects in the area may be generated based at least on an aggregation of the ultrasonic sensor (USS) data, the image data, and the RADAR data. A machine may be caused to perform one or more operations based at least on the output data. For instance, a first feature dataset, a second feature dataset, and a third feature dataset may be extracted from the USS data, the image data, and the RADAR data, respectively. A combined feature dataset corresponding to the output data may be generated based at least on the first feature dataset, the second feature dataset, and the third feature dataset.

As such, embodiments described herein may help overcome some deficiencies in object detection and corresponding object map generation (e.g., evidence grid maps (EGMs), occupancy maps, heat maps, etc.). For instance, the embodiments of the present disclosure may include generating object maps and/or other representations using data generated using sensor data corresponding to multiple sensor modalities, such as USS data, image data, RADAR data, and/or LiDAR data, in order to leverage the benefits of each sensor modality while mitigating their weaknesses. These embodiments of the present disclosure may provide improvements over some traditional approaches that use one type of sensor data such as the USS data, the image data, RADAR data, or the LiDAR data to generate the object maps and/or other representations. For instance, only relying on USS data may provide less accurate detections as distance of detection increases. Only relying on image sensors, such as cameras, is highly affected by detection conditions such as lack of light (e.g., nighttime), weather conditions (e.g., rain, fog, etc.), among others. RADAR sensors provide limited information in regard to the nature, size, or composition of detected objects. Further, RADAR sensors may not be as accurate with objects that are stationary or has low radar cross sections. LiDAR sensors require a large amount of computing resources and are not cost efficient due to high price compared to other sensors.

### BRIEF DESCRIPTION OF THE DRAWINGS

The present systems and methods for performing sensor fusion to generate an occupancy or evidence grid map for autonomous or semi-autonomous systems and applications are described in detail below with reference to the attached figured, wherein:

FIG. 1 illustrates an example data flow diagram for a process of generating a map(s) and/or other output representation(s) using a neural network(s) and sensor data generated using one or more types of sensors, in accordance with one or more embodiments of the present disclosure;

FIGS. 2A-2C illustrate example systems configured to process different types of input data, in accordance with one or more embodiments of the present disclosure;

FIGS. 3A-3C illustrate example neural networks for processing data in order to generate a map(s) and/or other output representation(s), in accordance with one or more embodiments of the present disclosure;

FIGS. 4A-4C illustrate example maps generated using a neural network(s), in accordance with one or more embodiments of the present disclosure;

FIG. 5 illustrates a flow diagram for a method for generating output data corresponding to one or more objects included in an area, in accordance with one or more embodiments of the present disclosure;

FIG. 6A is an illustration of an example autonomous vehicle, in accordance with one or more embodiments of the present disclosure;

FIG. 6B is an example of camera locations and fields of view for the example autonomous vehicle of FIG. 6A, in accordance with one or more embodiments of the present disclosure;

FIG. 6C is a block diagram of an example system architecture for the example autonomous vehicle of FIG. 6A, in accordance with one or more embodiments of the present disclosure;

FIG. 6D is a system diagram for communication between cloud-based server(s) and the example autonomous vehicle of FIG. 6A, in accordance with one or more embodiments of the present disclosure;

FIG. 7 is a block diagram of an example computing device suitable for use in implementing one or more embodiments of the present disclosure; and

FIG. 8 is a block diagram of an example data center suitable for use in implementing one or more embodiments of the present disclosure.

### DETAILED DESCRIPTION

One or more embodiments of the present disclosure may relate to generating output data corresponding to an area. The output data may correspond to one or more objects (static and/or dynamic) and/or features located in the area. In some embodiments, the one or more objects may include static objects (e.g., road signs, traffic lights, buildings, etc.), dynamic objects (e.g., cars, people, etc.), and/or topographical details or features of an environment (e.g., curbs, walls, hills, roads, etc.). In some embodiments, the output data may be generated based at least on input data obtained using multiple sensor modalities. For instance, the input data may include USS data obtained using ultrasonic sensors, image data obtained using cameras, RADAR data obtained using RADAR sensors, and/or LiDAR data generating using LiDAR sensors.

In some embodiments, USS data, RADAR data, and image data may be processed using a fusion neural network that is trained to generate output representations based at least on the USS data, the RADAR data, and the image data. For example, the neural network(s) may be trained to output at least a height map (e.g., a top-down height map, birds-eye-view (BEV) height map, etc.) and/or an occupancy or evidence grid map (e.g., a top-down occupancy map, a BEV occupancy map, etc.) For example, the neural network may extract feature data sets from the respective data modalities in which the feature data sets indicate objects and one or more features corresponding to the objects that may be identified from the underlying data modalities. In these and other embodiments, the neural network may be configured to extract and process the feature data corresponding to different modalities in parallel and/or in combination. For example, the neural network may be trained to process features related to the USS data, the RADAR data, and the image data together to generate the fused outputs.

In these and other embodiments, the feature extraction may be performed in various stages with respect to individual data modalities and with respect to combined data modalities. Performing the feature extraction in such a manner may help ensure that the different aspects of the different data modalities are considered by the neural network processing at multiple stages and corresponding layers of the neural networks.

Additionally or alternatively, in some embodiments, at least a portion of the sensor data may be processed before inputting the sensor data into the neural networks. For instance, the sensor data may be pre-processed in order to generate input data indicating respective locations (e.g., distances, angles, poses, etc.) of one or more objects, as indicated in the respective sensor data, relative to an ego-machine. The one or more neural networks may then process the sensor data and/or the pre-processed input data to generate the output representations.

One or more embodiments of the present disclosure may help improve reliability of objects maps and/or other sensor data representation types generated based on sensor data over some traditional approaches. For example, some traditional approaches may include systems that use sensor data from a single type of sensor modality, such as a camera, a RADAR sensor, a LiDAR sensor, or an ultrasonic sensor. Such approaches may be less reliable based on errors and/or noise and/or may require a large amount of computing resources, such as when LiDAR is used to generate the output representations. Other traditional approaches may include smaller combinations of sensor data, such as combinations that only include image data and RADAR data.

One or more embodiments of the present disclosure may improve reliability of object maps and/or other sensor data representations over some traditional approaches by using multiple types of sensors. For instance, the present systems and methods, in some embodiments, may process sensor data generated using multiple types of sensors in order to generate object maps and/or other sensor data representation types, such as an occupancy map, a height map, object detections (e.g., bounding shape locations, poses, etc.), and/or a projection image (e.g., projecting output detections, such as bounding shapes, from three-dimensional (3D) space onto a two-dimensional (2D) image).

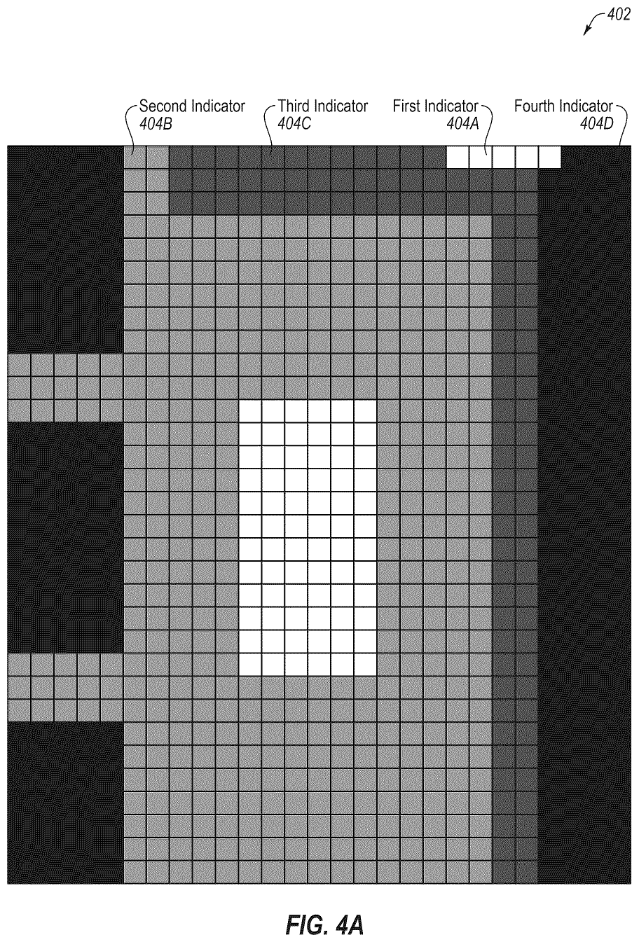

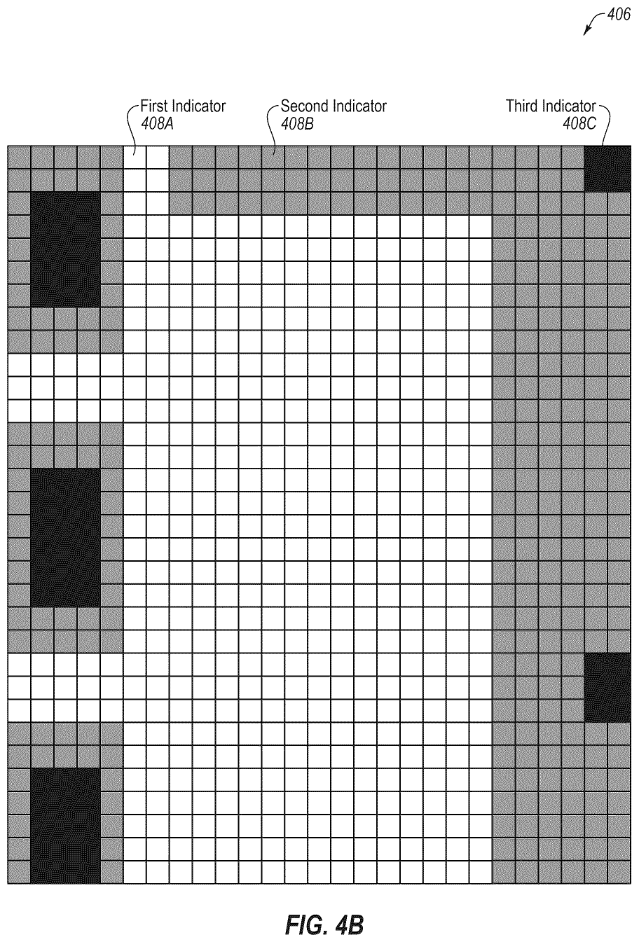

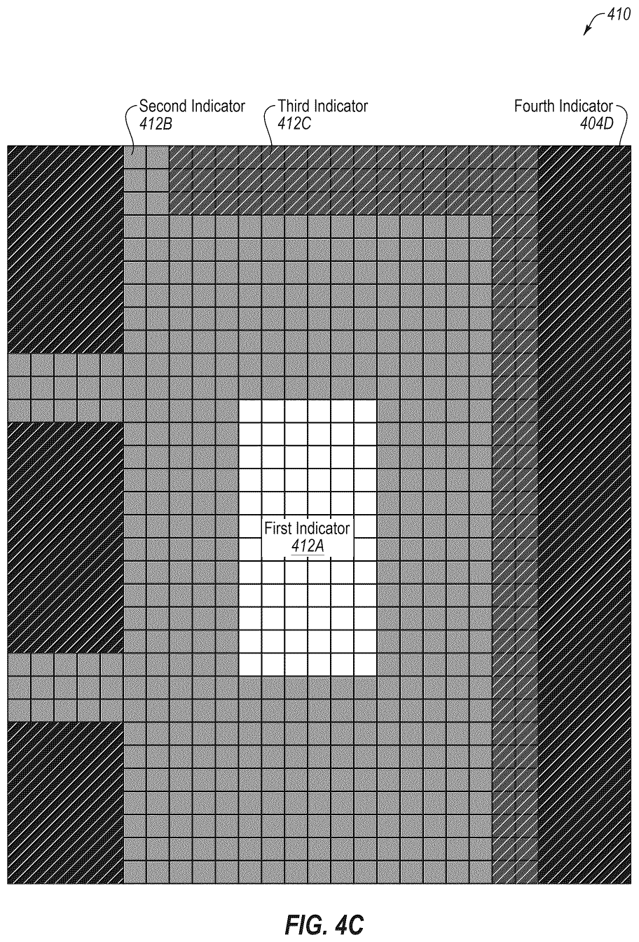

One or more embodiments of the present disclosure may be related to generating an object map associated with ego-machines and/or components of the one or more ego-machines, which may include any applicable machine or system that is capable of performing one or more autonomous or semi-autonomous operations. Example ego-machines may include, but are not limited to, vehicles (land, sea, space, and/or air), robots, robotic platforms, etc. By way of example, the ego-machine computing applications may include one or more applications that may be executed by an autonomous vehicle or semi-autonomous vehicle, such as an example autonomous vehicle 400 (alternatively referred to herein as “vehicle 400” or “ego-machine 400”) described with respect to FIGS. 4A-4D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, generative AI, data center processing, conversational AI (such as by employing one or more language models such as one or more large language models (LLMs)), light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations (e.g., systems that implement one or more language models, such as large language models (LLMs)), systems for performing one or more generative AI operations, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

The embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

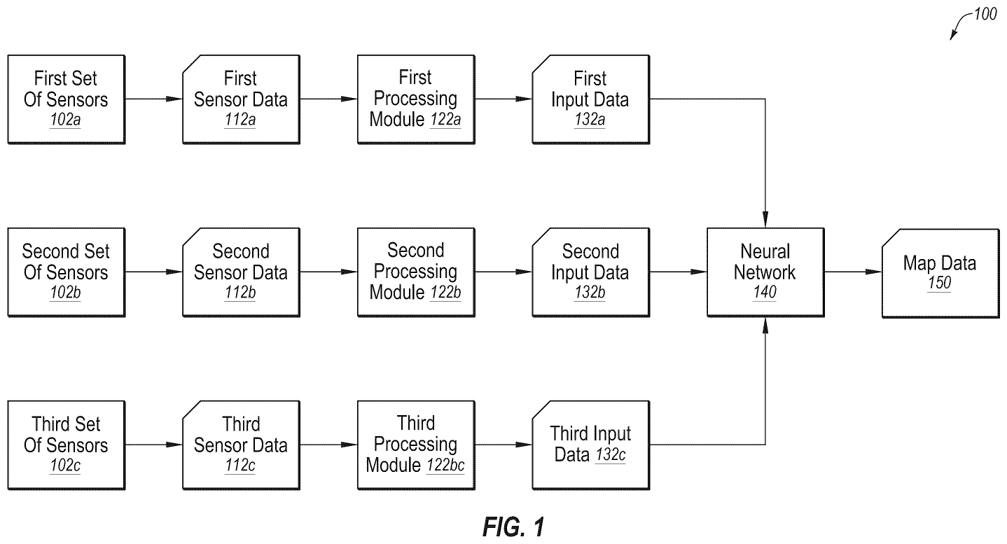

With respect to FIG. 1, FIG. 1 illustrates an example system 100 configured to generate a map (e.g., occupancy map, evidence grid map (EGM), heat map, etc.) and/or other output representations, in accordance with one or more embodiments of the present disclosure. In some embodiments, the system 100 may include multiple types of sensors associated with a machine. For instances, the system 100 may include a first set of sensors 102a, a second set of sensors 102b, and a third set of sensors 126c (collectively referred to as “sets of sensors 102”). In some embodiments, the sets of sensors 102 may include different types of sensors. For example, in some embodiments, the first set of sensors 102a may include one or more RADAR sensors, the second set of sensors 102b may include one or more ultrasonic sensors, and the third set of sensors 102c may include one or more image sensors. Additionally or alternatively, the system may include other types of sensors, such as LiDAR sensors.

In some embodiments, the sets of sensors may be configured to generate corresponding sensor data. For instance, the first set of sensors 102, the second set of sensors 104, and the third set of sensors 106 may generate first sensor data 112a, second sensor data 112b, and third sensor data 112c (collectively referred to as “sensor data 112”), respectively. In some instances, the sensor data 112 may be generated using a specific frame rate, such as, fifteen frames per second, thirty frames per second, sixty frames per second, and/or any other suitable frame rates. Different sensors may have different frame rates, in embodiments, and the sensor data used at any given iteration may be selected and/or transformed (e.g., ego-motion compensated) such that the sensor data from different modalities that may have different frame rates corresponds to substantially a same time.

In some embodiments, the system 100 may include multiple map processing modules corresponding to the sensor data 112. For instance, the system 100 may include a first processing module 122a, a second processing module 122b, and a third processing module 122c (collectively referred to as “processing modules 122”), configured to obtain and process the first sensor data 112a, the second sensor data 112b, and the third sensor data 112c, respectively. In these and other embodiments, the processing modules 122 may process the sensor data 112 to generate input data 132 representative of one or more locations of one or more objects with respect to the machine within the environment. For instance, the input data 132 may represent an image (e.g., a top-down image, a BEV image, etc.), a map (e.g., a top-down map, a BEV map, etc.), an envelope, and/or a projection (e.g., a range image) that indicates the locations of the objects relative to the machine.

In these and other embodiments, the processing modules 122 may generate the input data 132 based at least on respective sensor data 112. For instance, the first processing module 122a may process the first sensor data 112a to generate first input data 132a, the second processing module 122b may process the second sensor data 112b to generate second input data 132b, and the third processing module 122c may process the third sensor data 112c to generate third input data 132c. The processing modules 122 may include one or more operations suitable for the type of data included in the sensor data 112. For example, the first processing module 122a may include one or more operations or algorithms suitable to process RADAR data.

In some embodiments, the processing modules 122 may perform operations with respect to the sensor data 112 such that the input data 132 may be provided to a neural network 140. For instances, the processing modules 122 may be configured to identify objects in the sensor data 112 and transform the format of the image data 112 such that the locations of the identified objects may be provided to the neural network 140. For example, the input data 132 may correspond to grid maps that illustrate locations of the objects detected using different types of sensors. In some embodiments, the processing modules 122 may perform different operations based at least on the type of sensor data 112. For example, the first processing module 122a, the second processing module 122b, and the third processing module 122c may include different operations corresponding to the type of the sensors 102.

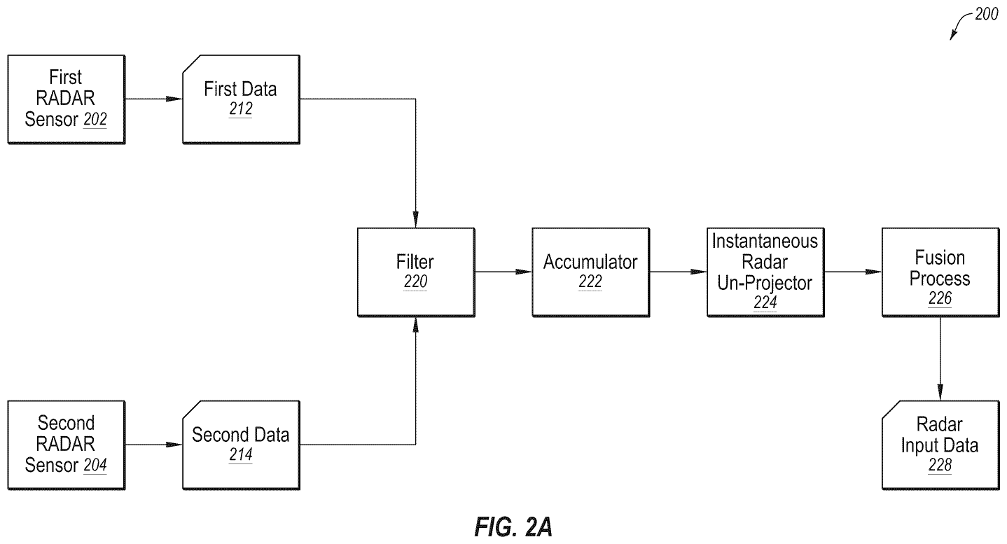

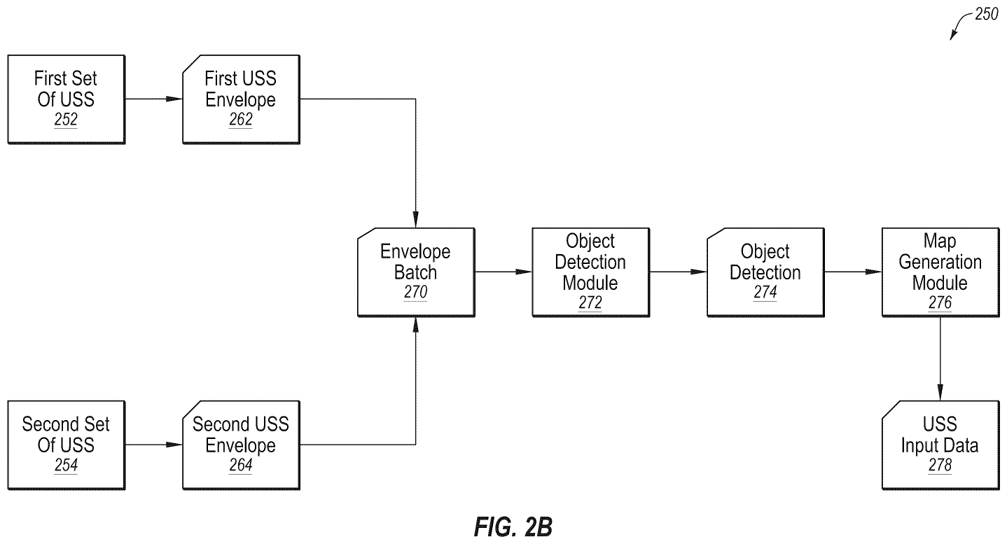

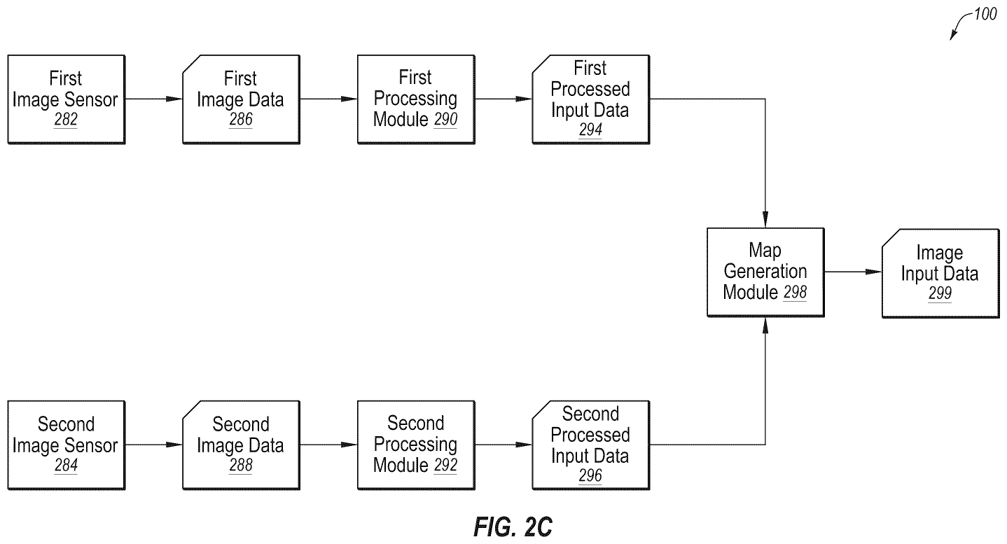

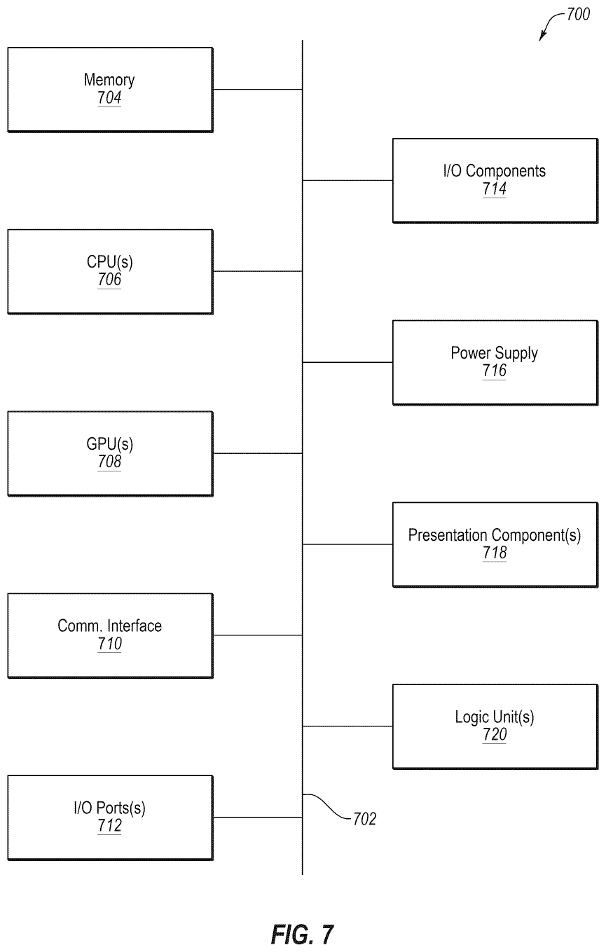

In some embodiments, one or more of the processing modules 122 may include code and routines configured to allow a computing system to perform one or more operations. Additionally or alternatively, one or more of the processing modules 122 may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, one or more of the processing modules 122 may be implemented using a combination of hardware and software. In the present disclosure, operations described as being performed by a particular module may include operations that the particular module may direct a corresponding computing system to perform. In these and other embodiments, one or more of the modules may be implemented by one or more computing systems, such as that described in further detail with respect to FIG. 7. Additionally or alternatively, FIGS. 2A-2C illustrate example systems or processes representative of the processing modules 122.

For instance, FIG. 2A illustrates a system 200 representative of an embodiment of the first processing module 122a of FIG. 1. Additionally, the system 200 may include sensors corresponding to the first set of sensors 102a. For instance, the system 200 may be configured to process RADAR data such as the first sensor data 112a. In some embodiments, the system 200 may include a first RADAR sensor 202 and a second RADAR sensor 204. While illustrated using two sensors, the system 200 may include any other number of RADAR sensors. In some embodiments, the first RADAR sensor 202 and the second RADAR sensor may be used to obtain first data 212 and second data 214, respectively. The first data 212 may include detection results using the first RADAR sensor 202 and the second data 212 may include detection results using the second RADAR sensor 204.

In some embodiments, the first data 212 and the second data 214 may be filtered using a filter 220. In some embodiments, the filter 220 may include hardware and/or software configured to identify and remove certain object detections in the first data 212 and/or the second data 214. In some embodiments, the object detections may be removed based at least on one or more constraints. In some instances, the one or more constraints may include radar cross section (RCS) values, range values, and ego-motion failures.

The RCS values may represent measures of how detectable objects are by radar, represented by the amount or radar energy reflected from the objects back to the radar sensors. In some embodiments, the object detections included in the first data 212 and the second data 214 that are associated with the RCS values below a threshold value may be removed. The range values may represent the detection ranges at which the first RADAR sensor 202 and the second RADAR sensor 204 may be configured to detect objects in based at least on specifications of the sensors. In some instances, the object detections indicated as being made outside of the detection ranges may be removed from the first data 212 and/or the second data 214. The ego-motion failures may indicate failures of the first RADAR sensor 202 and/or the second RADAR sensor 204 to accurately assess locations of the first RADAR sensor 202 and/or the second RADAR sensor 204 to be used as references locations for the detections. In some instances, the object detections that are made while the sensors are experiencing a certain level of ego-motion failures may be removed from the first data 212 and/or the second data 214.

In some embodiments, the first data 212 and the second data 214 that are filtered by the filter 220 may be obtained by an accumulator 222. In some embodiments, the accumulator 222 may be configured to accumulate and store the object detections in the first data 212 and the second data 214 that are not filtered by the filter 220. For instance, the accumulator 222 may buffer or temporarily store the first data 212 and the second data 214. The stored first data 212 and the second data 214 may be processed to compensate for any ego-motion that does not rise to the certain level (thus, not removed by the filter 220). For instance, the accumulator 222 may compensate for ego-motion offsets with respect to ego velocity and time. For example, the radar radial velocity (e.g., movement of the sensors) may be compensated by projecting the ego velocity into radar direction.

In some embodiments, the first data 212 and the second data 214 stored in the accumulator 222 may be cleared and the detections may be unprojected into an instantaneous grid map using instantaneous radar un-projector 224. The instantaneous grid map may include a visual representation of the first data 212 and the second data 214 over a specific area (e.g., an area corresponding to the detection range of the first RADA sensor 202 and the second RADAR sensor 204). The grid map may depict the radar echoes (e.g., signals) and corresponding returns that may represent objects, targets, and/or terrains within the detection ranges.

In some embodiments, the system 200 may further include a fusion process 226. In these and other embodiments, the fusion process 226 may be configured fuse the instantaneous grid maps generated by the instantaneous radar un-projector 224 into a global map. The global map may include detections made in different instances of radar detections. For instance, the instantaneous grid maps detected at different instances may be grouped together as the global map.

In some instances, prior to fusing the instantaneous grid map to the global map, the instantaneous grid map may be further filtered with respect to dynamic objects or obstacles. For instance, the objects with velocity values (e.g., speed of a detected object or obstacle) exceeding a velocity threshold value may be removed, such that the grid map includes static objects that provide better depiction of object locations. In these and other embodiments, the global map including the combination of different instances of the instantaneous grid maps may be provide as radar input data 228.

FIG. 2B illustrates a system 250 representative of an embodiment of the second processing module 122b and the second set of sensors 102b of FIG. 1. In some embodiments, the system 250 may include a first set of ultrasonic sensors 252 and a second set of ultrasonic sensors 254. While illustrated using two sets of sensors, the system 250 may include any other number of ultrasonic sensors. In some embodiments, the first set of ultrasonic sensors 252 and the second set of ultrasonic sensors 254 may be used to obtain a first USS envelope 262 and a second USS envelope 264, respectively. The first USS envelope 262 and the second USS envelope 264 may include locations of objects detected using the respective ultrasonic sensors. In the present disclosure, an envelope corresponding to a set of ultrasonic sensors may refer to information obtained from the ultrasonic sensors regarding shapes, sizes, distances, and/or characteristics of objects detected using the ultrasonic sensors. The first USS envelope 262 and the second USS envelope 264 may include corresponding USS data.

In some embodiments, the first USS envelope 262 and the second USS envelope 264 may be organized into one or more envelope batches 270. In some instances, the envelope batches 270 may be determined based at least on time intervals. For instance, the envelopes (e.g., the first USS envelope 262 and the second USS envelope 264) that are obtained within a defined time interval may be grouped together into an envelope batch. In some instances, the envelopes may be batched or grouped together based at least on defined number of readings. For instance, a batch may be defined to include a specific number of readings or envelopes. For example, an envelope batch may be defined to include five envelopes.

In some embodiments, the system 250 may include an object detection module 272 configured to generate an object detection 274 based at least on the envelope batch 270. For instance, the object detection module 272 may identify objects detected in the envelope batch 270 to define the object detection 274. In some instances, the objects may be identified based at least on a detection threshold. For instance, the detection threshold may distinguish between signals reflected from objects from background noise and/or interference. Patterns and/or features that satisfy the detection threshold may be identified from the envelope batch 270.

In some embodiments, the object detection module 272 may unproject the envelope batch 270 to identify the detected objects. For instance, the object detection module 272 may transform the USS data included in the envelope batch 270 to original form (e.g., same format as the first USS envelope 262 and the second USS envelope 264). For instance, the USS data may be analyzed to determine individual object detections included in individual USS envelopes and to combine the individual object detections together onto a same coordinate plane. In some instances, the coordinate may correspond to detection coordinates of the first set of ultrasonic sensors 252 and the second set of ultrasonic sensors 254.

In some embodiments, the unprojected envelope batches 270 may be obtained by a map generation module 276 to generate USS input data 278. In these and other embodiments, the USS input data 278 may include object detections using the first set of ultrasonic sensors 252 and/or the second set of ultrasonic sensors 254. For instance, the map generation module 276 may stack the unprojected envelope batches 270 together to define a map (e.g., a grid map) that represents locations of the objects detected using the first set of ultrasonic sensors 252 and/or the second set of ultrasonic sensors 254. For example, the USS input data 278 may include a USS grid map illustrating locations of the detected objects as sets of coordinates within the grid map defined by a certain coordinate system. In some embodiments, the USS input data 278 (e.g., the grid map) may correspond to the second input data 132b of FIG. 1.

FIG. 2C illustrates a system 280 representative of an embodiment of the third processing module 122c and the third set of sensors 102c of FIG. 1. In some embodiments, the system 280 may include a first image sensor 282 and a second image sensor 284 corresponding to the third set of sensors 102c. While illustrated using two image sensors, the system 280 may include any other number of image sensors. In some embodiments, the first image sensor 282 and the second image sensor 284 may be used to obtain first image data 286 and second image data 288, respectively. In some embodiments, the first image sensor 282 and the second image sensor 284 may include any types of sensors suitable to obtain image data. For example, the first image sensor 282 and the second image sensor may include different types of cameras such as fisheye cameras. For instance, the first image sensor 282 may include a first camera configured to capture images of a scene corresponding to the first image data 286, and the second image sensor 284 may include a second camera configured to capture images of the scene corresponding to the second image data 286. In some embodiments, the first image data 286 and the second image data 288 may include one or more objects and/or features present in the corresponding scene. In some embodiments, the first image data 286 and the second image data 288 may include one or more image frames.

In some embodiments, the first image data 286 and the second image data 288 may be obtained and processed using a first processing module 290 and a second processing module 292, respectively. In these and other embodiments, the first processing module 290 and the second processing module 292 may be configured to respectively generate first processed image data 294 and second processed image data 296 based at least on the first image data 286 and the second image data 288. In some embodiments, the first processing module 290 and the second processing module 292 may be configured to modify formats of the first image data 286 and the second image data 288 to be compatible. For instance, the first image data 286 and the second image data 288 may include different resolutions and/or sizes. In such instances, the first processing module 290 and/or the second processing module 292 may process the first image data 286 and/or the second image data 288 such that the resolutions and/or the sizes are uniform. For example, the first processing module 290 and the second processing module 292 may scale and/or crop individual image frames of the first image data 286 and the second image data 288, respectively.

Additionally, in some embodiments, the first processed image data 294 and the second processed image data 296 may be encoded such that the first processed image data 294 and the second processed image data 296 such that the analog image data may be converted to digital data suitable for further processing.

In some embodiments, the system 280 may include a map generation module 298 configured to generate image input data 299 (e.g., the third input data 132c of FIG. 1) based at least on the first processed image data 294 and the second processed image data 296. In some embodiments, the image input data 299 may include a map (e.g., a grid map) representing locations of objects detected using the first image sensor 282 and/or the second image sensor 284. In some embodiments, the image input data 299 may include a BEV map. For instance, the map generation module 298 may include one or more operations to transform the first processed image data 294 and the second processed image data 296 from perspectives of the first image sensor 282 and the second image sensor 284 to a BEV perspective. For instance, the image data captured using the image sensors may be converted to a flat, top-down view such that pixels form the image data are mapped to corresponding locations in the BEV.

Returning to FIG. 1, in some embodiments, the neural network 140 may be configured to process the input data 132. In some embodiments, the neural network 140 may be trained to process the input data 132 and, based on the processing, output map data 150 associated with an environment. The map data 150 may include, but is not limited to, a height map, an occupancy map, a height/occupancy map, a distance map, and evidence grid map, among others. In some instances, one or more of the maps may include a BEV map, a top-down map, among others. In some instances, the neural network 140 may be trained to output a single map, such as a single occupancy map, a single height map, a single height/occupancy map, or a single distance map. For instance, the neural network 140 may be configured to process the first input data 132a, the second input data 132b, and the third input data 132c together to combine the object detections present in the first input data 132a, the second input data 132b, and the third input data 132c into the map data 150.

In some embodiments, the neural network 140 may be trained based at least on the different types of input data 132. For instance, the neural network 140 may be trained to process the RADAR data (e.g., the first input data 132a), the USS data (e.g., the second input data 132b), the image data (e.g., the third input data 132c), another type/modality of sensor data, and/or any combination thereof. In these and other embodiments, the neural network 140 may obtain and process the input data 132 from different modalities together. For instance, the neural network 140 may obtain the first input data 132a, the second input data 132b, and the third input data 132c. The neural network 140 may be trained to process the input data 132 to combine the first input data 132a, the second input data 132b, and the third input data 132c to generate the map data 150.

Although referred to as “a” neural network, the neural network 140 may include one or more neural networks that may be configured to perform, individually or collectively, one or more operations described herein with respect to the neural network 140. Further, the neural network may be implemented in a distributed or consolidated manner depending on particular implementations without departing from the scope of the present disclosure.

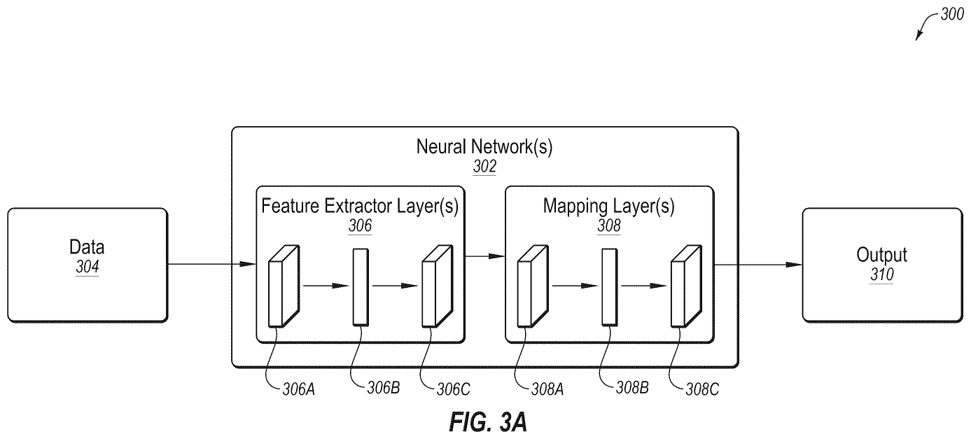

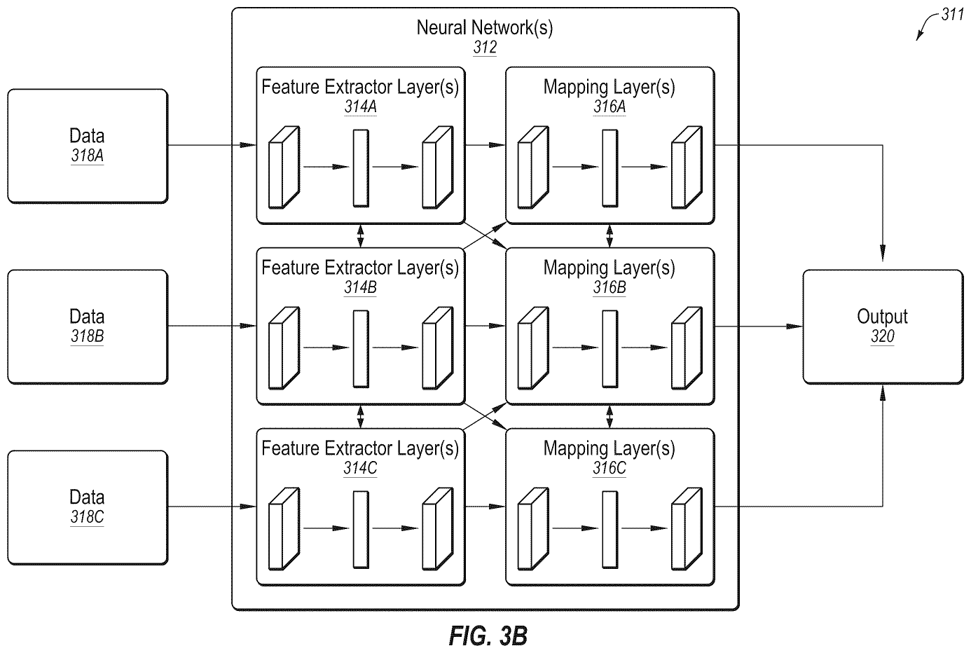

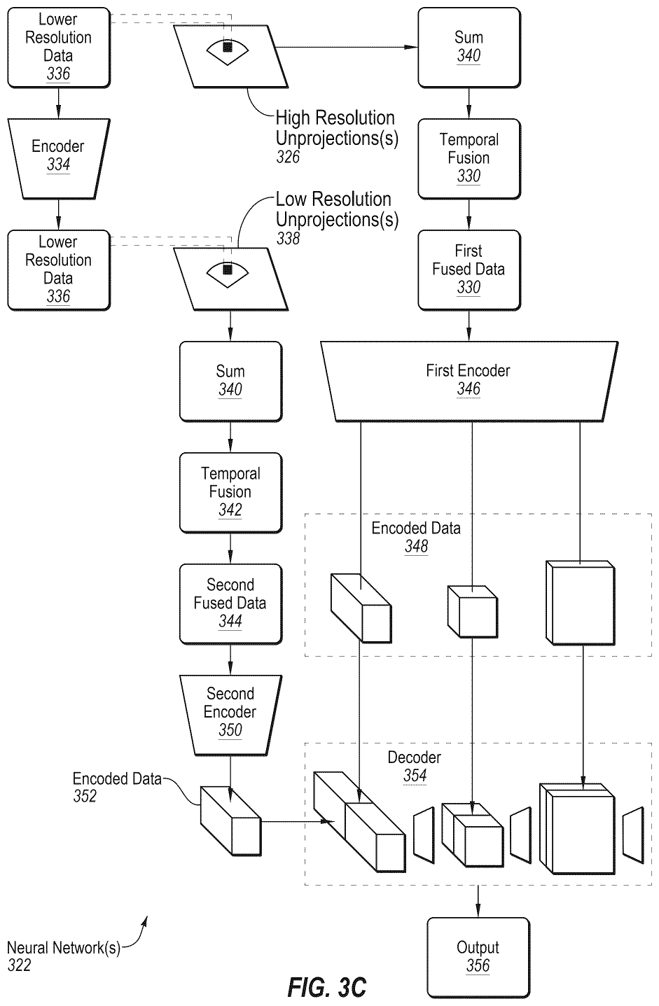

FIG. 3A is an illustration of an example neural network 302 in accordance with one or more embodiments of the present disclosure. For example, the neural network 302 may be an example of the neural network 140 and/or a portion of the neural network 140 of FIG. 1.

In some embodiments, the neural network 302 may include any type of suitable neural networks, such as a deep neural network (DNN) and/or a convolutional neural network (CNN). The neural network 302 may obtain data 302 as input. In these and other embodiments, the data 302 may be analogous or similar to the input data 132 of FIG. 1. For example, in some embodiments the data 302 may include the first input data 132a, the second input data 132b, and/or the third input data 132c.

In some embodiments, the neural network 302 may include one or more layers that may be used to perform operations with respect to the data 304. For instance, the neural network 302 may include one or more feature extractor layers 306. The feature extractor layers 306 may include any number of layers. For instance, while FIG. 3A illustrates a first extractor layer 306a, a second extractor layer 306b, and a third extractor layer 306c, the neural network 302 may include fewer or more feature extractor layers 306. In these and other embodiments, the feature extractor layers 306 may be configured to extract meaningful information and/or features from raw data.

In some embodiments, the feature extractor layers 306 may include one or more convolutional layers. For instance, the first extractor layer 306a may correspond to a convolutional layer. In such instances, the convolutional layers may be configured to detect different patters or features, such as edges and textures, across the data 302. For instance, the convolutional layers may include filters or kernels that may be applied to the data 302.

In some embodiments, the feature extractor layers 306 may include one or more pooling layers. For instance, the second extractor layer 306b may correspond to a pooling layer. The pooling layers may be configured to reduce spatial dimension of the data 302 while retaining information included in the data 302. In some embodiments, the feature extractor layers 306 may include multiple pooling layers. For example, the feature extractor layers 306 may include alternating convolutional layers and pooling layers. In such instance, the dimensions of the data 302 may be progressively reduced.

Additionally or alternatively, the feature extractor layers 306 may include one or more normalization layers which may correspond to the third extractor layer 306c. The normalization layers may normalize the activations of neurons or the outputs of the feature extractor layers 306. The normalization layers may be configured to stabilize and/or enhance the training process (of the neural network 302.

In some embodiments, the feature extractor layers 306 may include other layers additionally or alternatively to the convolutional layers, pooling layers, and the normalization layers. For instance, the feature extractor layers 306 may include one or more rectified linear unit (ReLU) layers and/or one or more deconvolutional layers in addition to or in place of the other layers described herein. The ReLU layers may include ReLU functions that may be applied to the data 302 to introduce non-linearity to the data 302 by outputting zeros for negative values and letting the positive values pass through unchanged.

The deconvolutional layers may be used to perform up-sampling on the output of a prior layer. For example, the deconvolutional layers may be used to up-sample to a spatial resolution that is equal to the spatial resolution of the input images to the neural network 302 or used to up-sample to the input spatial resolution of a next layer.

In some embodiments, the neural network 302 may include one or more mapping layers 308. The mapping layers 308 may be configured to obtain the output of the feature extractor layers 306 to generate an output 310. In these and other embodiments, the output 310 may include map data determined based at least on the features extracted from the data 302 by the feature extractor layers 306. In some embodiments, the output 310 may correspond to the map data 150 of FIG. 1.

In some embodiments, the output 310 may represent one or more maps and/or other output representations (e.g., confidence vectors, regressed outputs, bounding shape outputs, segmentation masks, occupancy or height grids, etc.). For instance, and as described herein, the output 310 may include, but is not limited to, a height map(s), an occupancy map(s), a height/occupancy map(s), a distance map(s), among others.

In some embodiments, the mapping layers 308 may include different types of layers. For instance, the mapping layers may include a first mapping layer 308a, a second mapping layer 308b, and a third mapping layer 308c. While illustrated as having three layers, the mapping layers 308 may include any suitable number of layers.

In some embodiments, the mapping layers 308 may include types of layers similar to the feature extractor layers 306. For instance, the mapping layers 308 may include one or more convolutional layers, one or more pooling layers, one or more normalization layers, one or more ReLU layers, and/or one or more deconvolutional layers. The first mapping layer 308a, the second mapping layer 308b, and the third mapping layer 308c may correspond to different types of layers.

FIG. 3B illustrates another example of a neural network 312, in accordance with one or more embodiments of the present disclosure. The neural network 312 may also be an example of the neural network 140 of FIG. 1.

In some embodiments, the neural network 312 may include first feature extractor layers 314a and first mapping layers 316a associated with a first data type and second feature extractor layers 314b and second mapping layers 316b associated with a second data type. For instance, the first feature extractor layers 314a and the first mapping layers 316a may be trained to process the first type of sensor data such as the first sensor data 112a of FIG. 1. The second feature extractor layers 314b and the second mapping layers 316b may be trained to process the second type of sensor data such as the second sensor data 112b of FIG. 1. In some embodiments, the neural network 312 may include third feature extractor layers 314c and third mapping layers 316c associated with a third data type such as the third sensor data 112c of FIG. 1.

In some embodiments, the first feature extractor layers 314a, the second feature extractor layers 314b, and the third feature extractor layers 314c may respectively correspond to the feature extract layers 306 of FIG. 3A, and the first mapping layers 316a, the second mapping layers 316b, and the third mapping layers 316c may respectively correspond to the mapping layers 308 of FIG. 3A. For instance, the feature extractor layers 314 and the mapping layers 316 may include similar layers as the feature extractor layers 306 and the mapping layers 308.

In some embodiments, the feature extractor layers 314 and the mapping layers 316 may be related such that the data processed by the layers may be transferred among the layers. For instance, the output from the first feature extractor layer 314a may be provided to the first mapping layer 316a, the second feature extractor layers 314b, and/or the second mapping layers 316b, and vice versa. Additionally, the output from the second feature extractor layer 314b may be provided to the second mapping layer 316b, the first feature extractor layers 314a, and/or the second mapping layers 316b, and vice versa.

For instance, the first feature extractor layers 314a, the second feature extractor layers 314b, and the third feature extractor layers 314c may extract features detected using different sensor modalities. For example, the first feature extractor layers 314a may extract features from the first data 318a corresponding to RADAR data, the second feature extractor layers 314b may extract features from the second data 318b corresponding to image data, and the third feature extractor layers 318c may extract features from the third data 318c corresponding to USS data.

In some embodiments, the extracted features from the feature extractor layers 314 may be combined and introduced to the mapping layers 316. For example, the extracted features from the feature extractor layers 314 may all be provided to the second mapping layers 316b. The second mapping layers 316b may be configured to determine a map based at least on the extracted featured from the first feature extracted layers 314a, the second feature extractor layers 314b, and the third feature extractor layers 314c. In some embodiments, the first mapping layers 316a and the third mapping layers 316c may be configured to determine an output (e.g., a map) based solely on features extracted using the corresponding feature extractor layers 314. For instance, the first mapping layers 316a may determine the map using the features from the first feature extractor layers 314a and the third mapping layers 316c may determine the map based on the features from the third feature extractor layers 314c.

For instance, the first feature extractor layers 314a may process the first data 318a corresponding to the RADAR data to determine detected features in the first data 318a. The first mapping layer 316a may use the detected features to determine a first map of detected features based on the solely on the RADAR data. The second feature extractor layers 314b may process the second data 318b corresponding to the image data to determine detected features in the second data 318b. The second mapping layer 316b may use the detected features to determine a second map of detected features based on the solely on the image data. Additionally, the third feature extractor layers 314c may process the third data 318c corresponding to the USS data to determine detected features in the third data 318c. The third mapping layer 316c may use the detected features to determine a third map of detected features based solely on the USS data.

In addition to the maps determined based on data corresponding to different modalities, the neural network 312 may determine a fourth map based on data corresponding to different modalities. For instance, the features extracted from the data 318 using the feature extractor layers 314 may be all provided to the second mapping layers 316b to determine the fourth map. For instance, the second mapping layers 316b may combine the features extracted from the RADAR data, the image data, and the USS data. In some instances, the features identified from data corresponding to different modalities may be provided to individual layers of the second mapping layers 316b such that the different features are repeatedly processed and/or combined using the second mapping layers 316b.

In these and other embodiments, the first map, the second map, the third map, and the fourth map may be combined to determine the output 320. In such instances, determining the first map, the second map, and the third map separately and combining with the fourth map may allow the neural network 312 to determine the output 320 while considering featured detected using all modalities. Contrastingly, some traditional approaches, in which a neural network merely combine the features identified using different sensor modalities together, may end up neglecting certain features detected using certain modalities.

For example, the neural network may ignore the RADAR data and/or the USS data while the neural network tries to optimize the accuracy of the process in the fastest approach possible. For instance, the neural network may ignore the RADAR data and/or the USS data as the image data may provide more accurate detections in most instances. However, such an approach may cause the neural network to miss certain detections obtained using the RADAR data and/or the USS data for instances in which the RADAR data and/or the USS data may be more accurate than the image data. For instance, the RADAR data may be more accurate than the image data in weather conditions that may affect the quality of the image data (e.g., rainy weather), and the USS data may be more accurate than the image data in low-light environments. Contrastingly, separately identifying the first map, the second map, and the third map, in addition to the fourth map, in accordance with one or more embodiments of the present disclosure, may allow the neural network 312 to consider all detections included in the RADAR data, the image data, and the USS data in generating the output 320.

FIG. 3C illustrates an example neural network 322 that uses temporal fusion to generate one or more maps and/or other types of outputs 356, in accordance with one or more embodiments of the present disclosure. The neural network 322 may be configured to obtain data 324. The data 324 may include data obtained using one or more sensors and/or data obtained by processing the data obtained using the one or more sensors. For instance, the data 324 may correspond to the first sensor data 112a, the second sensor data 112b, and/or the third sensor data 112c of FIG. 1. Additionally or alternatively, the data 324 may include the first input data 132a, the second input data 132b, and/or the third input data 132c of FIG. 1.

In some embodiments, the neural network 322 may be trained to generate one or more high resolution unprojections 326. The high resolution unprojections 326 may include a map, an image, and/or other data formats that may indicate locations of objects within an environment. In some instances, the high resolution unprojections 326 may be generated using one or more processes described with respect to FIGS. 2A-2C. The process of determining the high resolution unprojections 326 may further correspond to operations that may be performed by the processing modules 122 of FIG. 1. In some embodiments, the neural network 322 may generate multiple high resolution unprojections 326 for a single instance in time. In such instances, the neural network 322 may combine the multiple high resolution unprojections 326 corresponding to the same single instance in time at a sum process 328 to generate a combined high resolution unprojection for the single instance in time.

In these and other embodiments, the neural network 322 may generate combined high resolution unprojections 326 corresponding to different instances in time. For instance, the high resolution unprojections 326 of objects at different times may be generated (e.g., unprojections of objects at different instances as the machine travels). In such instances, the neural network 322 may fuse the high resolution unprojections 326 corresponding to different times instances together at temporal fusion process 330 to generate first fused data 332. In these and other embodiments, the temporal fusion process 330 may align the high resolution unprojections 326 based at least on the time instances, such that the high resolution unprojections 326 are sequentially aligned.

In some instances, the sequential order of the time instances associated with the high resolution unprojections 326 may be determined based at least on analysis of the high resolution unprojections 326 representing motion between different instances. For instance, the neural networks 322 may use the data to determine a lateral motion, a longitudinal motion, and/or an orientation motion (e.g., a change in orientation), between a first instance in time and a second instance in time. The neural networks 322 may use the lateral motion, the longitudinal motion, the orientation motion, and/or combination thereof to transform first high resolution unprojections associated with the first instance in time to second high resolution unprojections associated with a second instance in time, or vice versa. For instance, if the center of the first high resolution unprojections represents the location (e.g., an origin located on a vehicle, such as on a center of a rear axle of the vehicle, or at another location) of the vehicle in the environment, the neural network 322 may transform the first high resolution unprojections associated with the first instance in time by moving the center of the first high resolution unprojections based on the lateral and/or longitudinal motion and/or change the orientation of the first high resolution unprojections based on the orientation motion. The neural network 322 may fuse the first high resolution unprojections associated with the first instance in time with the second high resolution unprojections associated with the second instance in time to generate the first fused data 332.

In some embodiments, the neural network 322 may include an encoder 334 configured to generate lower resolution data 336 based at least on the data 324. The encoder 334 may process the data 324 such that the resolution of the data 324 is lower. In these and other embodiments, the neural network 322 may un-project the lower resolution data 336 to generate low resolution unprojections 338 including images and/or maps representing locations of objects within the environment. In some embodiments, the neural network 322 may generate the low resolution unprojections 338 in a similar manner as the high resolution unprojections 326. In some instances, the low resolution unprojections 338 may be generated using one or more processes described with respect to FIGS. 2A-2B.

In the present disclosure, use of the terms “high resolution” and “low resolution” are meant to provide a comparison between data or unprojections having higher or lower resolution with respect to each other and are not meant as absolute terms in all instances. For example, in some instances, first data may be deemed as “high resolution” when used with second data having a lower resolution. Additionally or alternatively, the first data may be deemed as “low resolution” when used with third data having a higher resolution.

In some embodiments, the neural network 322 may perform one or more processes with respect to the low resolution unprojections 338. In some embodiments, the one or more processes may be similar to processes performed with respect to the high resolution unprojections 326. For example, the processes performed with respect to the low resolution unprojections 338 may include a sum 340 and a temporal fusion 342, which may correspond to the sum process 328 and the temporal fusion process 330, respectively. For instance, the sum 340 may combine the low resolution unprojections 338 corresponding to a same time instance, and the temporal fusion 342 may fuse the combined low resolution unprojections based at least on sequential time instances to generate second fused data 344.

In some embodiments, the neural network 322 may use an encoder 346 to encode the fused data 332 to generate first encoded data 348. In some instances, the encoded data 348 may be generated using one or more layers of the encoder 346. For instance, the first encoded data 348 may be generated using connected layer of the encoder 346, skipped layers of the encoder 346, among others. Additionally, the neural network 322 may use an encoder 350 to encode the fused data 344 to generate encoded data 352.

In some embodiments, the neural network 322 may include a decoder 354 configured to decode the first encoded data 348 with the second encoded data 352 to generate an output 356. In some instances, the decoder 354 may decode the first encoded data 348 with the second encoded data 352 using one or more layers. For instance, a first portion of the first encoded data 348 may be combined with a first portion of the second encoded data 352, and applied to a first layer of the decoder 354, a second portion of the first encoded data 348 may be combined with a second portion of the second encoded data 352 and applied to a second layer of the decoder 354, and a third portion of the first encoded data 348 may be combined with a third portion of the second encoded data 352 and applied to a third layer of the decoder 354.

In these and other embodiments, the output 356 may represent one or more maps and/or other output representations, such as, but not limited to, a height map, an occupancy map, a height/occupancy map, a distance map, among others. In some embodiments, the output 356 may correspond to the map data 150 of FIG. 1.

In some embodiments, the processes described with respect to the neural network 322 may be performed with respect to different types of data obtained using different sensor modalities. For instance, the neural network 322 may determine the output 356 with respect to RADAR data (e.g., the first data 318a of FIG. 3B), the image data (e.g., the second data 318b of FIG. 3B), and the USS data (e.g., the third data 318c of FIG. 3B). In some embodiments, the neural network 322 may determine process the RADAR data, the image data, and the USS data together in parallel. In some embodiments, the neural network 322 may determine a combined map combining the features identified in data obtained using different sensor modalities.

In some embodiments, the combined map may be determined following the processes outlined in FIG. 3C. In these and other embodiments, different processes of the neural network 322 may be performed with respect to combined data (e.g., combination of the RADAR data, the image data, and the USS data). For instance, high resolution unprojections 326 may be determined for the RADAR data, the image data, and the USS data, which may be combined to generate a combined high resolution unprojections. Such combination of different data may be performed with respect to individual processes such that unprojections corresponding to certain sensor modalities are not neglected over another sensor modality.

FIG. 4A illustrates an example height map 402, in accordance with one or more embodiments of the present disclosure. In some embodiments, the height map 402 may correspond to the first input data 132a, the second input data 132b, and/or the third input data 132c of FIG. 1. In some embodiments, the height map 402 may represent the map data 150 combining the first input data 132a, the second input data 312b, and the third input data 132c using the neural network 140. For instance, different features extracted from the data obtained using different sensor modalities may be analyzed to determine heights of the features. In some embodiments, the height map 402 may include a first indicator 404a, a second indicator 404b, a third indicator 404c, and a fourth indicator 404d (collectively referred to as the indicators 404). The first indicator 404a, the second indicator 404b, the third indicator 404c, and the fourth indicator 404d may represent various heights of the environment surrounding a machine and/or areas within the environment for which the machine is uncertain of the height. While FIG. 4A illustrates the height map 402 as including four indicators 404, the height map 402 may include any suitable number of indicators 404. Additionally, while FIG. 4A illustrates the differences between the indicators 404 using different shades and/or colors, the height map 402 may be represented using any other suitable types of indicators 404, such as shading, patterns, shapes, among others.

In some embodiments, the first indicator 404a may indicate areas of the environment for which the machine is uncertain of the heights. For instance, the machine may be uncertain of heights for central region of the height map 402 as the central region corresponds to the machine. The sensors associated with the machine may be less capable of generating sensor data representing the area corresponding to the machine. The height map 402 may include additional regions with uncertain heights due to various reasons (e.g., failure to detect due to obstacles, sensor errors, computing errors, etc.). In these and other embodiments, the second indicators 404b of the height map 402 may represent areas of the environment that include a first height, the third indicators 404c may represent areas of the environment including a second height, and the fourth indicator 404d may represent areas of the environment that include a third height. In some instances, the second height may be greater than the first height, and the third height may be greater than the second height.

In some embodiments, individual squares and/or rectangles of the height map 402 may include a pixel or a point representing an area of the environment. For example, the height map 402 may indicate the respective height of individual pixels or points. In other embodiments, an individual square and/or a rectangle of the height map 402 may include multiple pixels or points representing an area of the environment. Additionally, in some embodiments, the height map 402 may include confidence scores associated with the heights. For example, the height map 402 may include information regarding heights associated with individual pixels along with the confidence scores associated with the provided heights associated with the individual pixels. For example, the height and/or confidence scores may be encoded to the pixel values for the pixels or points, and the location of the pixels or points may indicate lateral and longitudinal locations in 3D space, the resulting map or grid represents 3D information about the environment.

FIG. 4B illustrates an example occupancy map 406, in accordance with one or more embodiments of the present disclosure. In some embodiments, the occupancy map 406 may correspond to the first input data 132a, the second input data 132b, and/or the third input data 132c of FIG. 1. In some embodiments, the occupancy map 406 may represent the map data 150 combining the first input data 132a, the second input data 312b, and the third input data 132c using the neural network 140. In some embodiments, the occupancy map 406 may include a first indicator 408a, a second indicator 408b, and a third indicator 408c (collectively referred to as “the indicators 408”). The indicators 408 may represent various occupancies associated with the environment surrounding the machine and/or areas within the environment for which the machine is uncertain of the occupancy. In some embodiments, the indicators 408 may be distinguished using different shades. In other embodiments, the indicators 408 may be distinguished using other features such as patterns, shapes, colors, among others.

In some embodiments, the first indicator 408a may indicate areas of the environment that are not occupied (e.g., areas of the environment for which the machine is free to navigate). The second indicator 408b may indicate areas of the environment that are occupied (e.g., areas of the environment for which the machine may not navigate). Additionally or alternatively, the third indicator 408c may indicate areas of the environment for which the machine is uncertain about the occupancy.

In these and other embodiments, individual squares or rectangles of the occupancy map 406 may include individual pixels representing an area of the environment. For example, the occupancy map 406 may indicate the respective occupancy associated with one or more pixels (e.g., individual pixel). In other embodiments, individual squares or rectangles of the occupancy map 406 may include multiple pixels representing an area of the environment. Additionally, in some embodiments, the occupancy map 406 may include confidence scores associated with the occupancies. For example, the occupancy map 406 may indicate both the occupancy associated with the pixel and the confidence score associated with the occupancy of the pixel.

In some embodiments, the occupancy map 406 may correspond to the height map 402 of FIG. 4A. For example, the areas of the height map 402 that include heights less than a threshold height and/or areas of the height map 402 that are associated with the location of the machine may correspond to the unoccupied areas of the occupancy map 406. For instance, the areas of the height map 402 that include the second indicator 404b may include heights that are less than the threshold height. Additionally, areas of the height map 402 that include heights that are equal to or greater than the threshold height may correspond to the occupied areas of the occupancy map 406. For instance, areas of the height map 402 that include the third indicator 404c and the fourth indicator 404d may include heights that are equal to or greater than the threshold height.

FIG. 4C illustrates an example height/occupancy map 410, in accordance with one or more embodiments of the present disclosure. In some embodiments, the height/occupancy map 410 may correspond to the first input data 132a, the second input data 132b, and/or the third input data 132c of FIG. 1. In some embodiments, the height/occupancy map 410 may represent the map data 150 combining the first input data 132a, the second input data 312b, and the third input data 132c using the neural network 140. In some embodiments, the height/occupancy map 410 may include a first indicator 412a, a second indicator 412b, a third indicator 412c, and a fourth indicator 412d (collectively referred to as “the indicators 412”). The indicators 412 may represent the various heights and/or occupancies of the environment surrounding the machine. While the height/occupancy map 410 is illustrated with four indicators 412, the height/occupancy map 410 may include any other suitable number of indicators 412. While the height/occupancy map 410 illustrates the indicators 412 using colors and patterns, in other embodiments, the height/occupancy map 410 may use other types of indicators 410.

In some embodiments, the first indicator 412a of the height/occupancy map 410 may indicate areas of the environment for which the vehicle is uncertain of the height. For instance, the machine may be uncertain about the central regions of the height/occupancy map 410 as the central region of the height/occupancy map 410 may correspond to the location of the machine. As such, the sensors associated with the machine may be unable to generate sensor data representing that area of the environment. The machine may also be uncertain about other areas of the environment for which the sensor data 102 does not represent (e.g., the areas may be blocked by other objects). The second indicator 412b of the height/occupancy map 410 may indicate areas of the environment that include a first height, the third indicators 412c of the height/occupancy map 410 may indicate areas of the environment that include a second height, and the fourth indicator 412d of the height/occupancy map 410 may indicate areas of the environment that include a third height. In some instances, the second height may be greater than the first height, and the third height may be greater than the second height.

Additionally, the indicators 412 of the height/occupancy map 410 may indicate whether the areas of the environment are occupied or unoccupied. For instance, the first indicator 412a and the second indicator 412b may include a first pattern (e.g., a solid pattern) indicating that corresponding regions and/or pixels are unoccupied, while the third indicator 412c and the fourth indicator 412d may include a second pattern (e.g., a stripped pattern) indicating that corresponding regions and/or pixels are occupied. In these and other embodiments, the height/occupancy map 410 may indicate both the heights and the occupancies associated with the environment. For instance, the height/occupancy map 410 may illustrate information present in both the height map 402 of FIG. 4A and the occupancy map 406 of FIG. 4B.

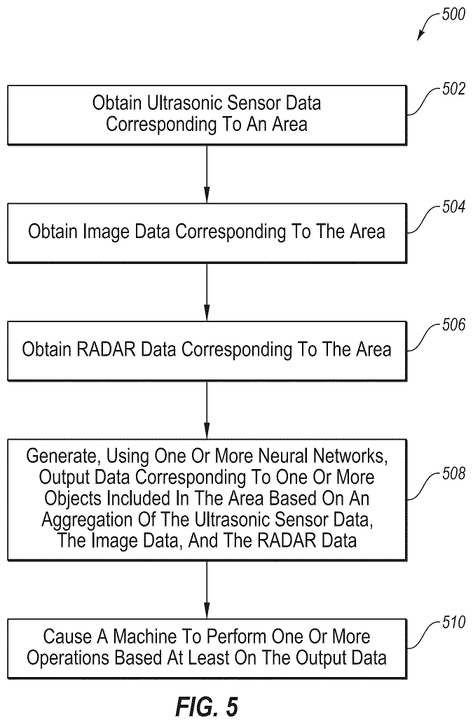

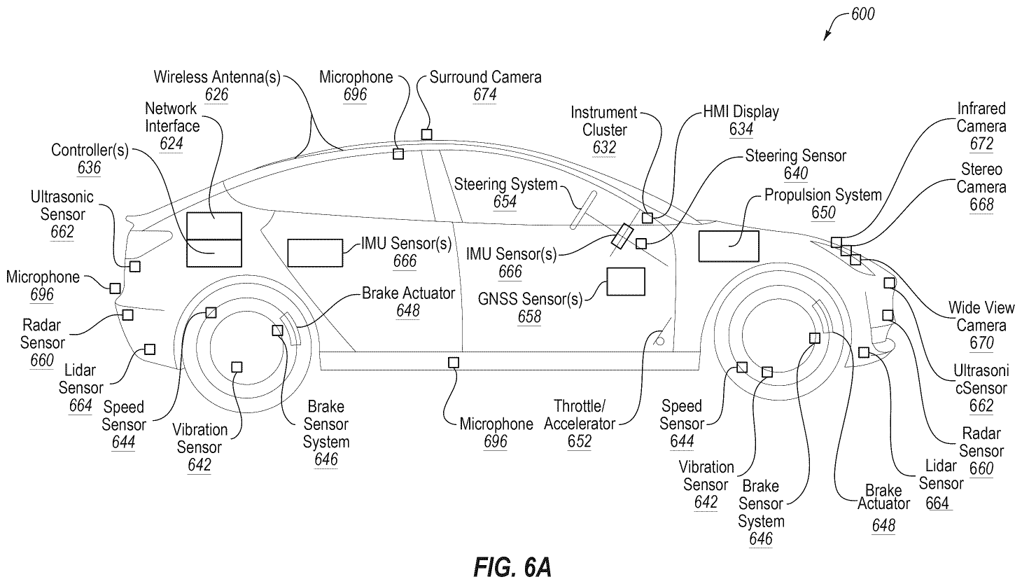

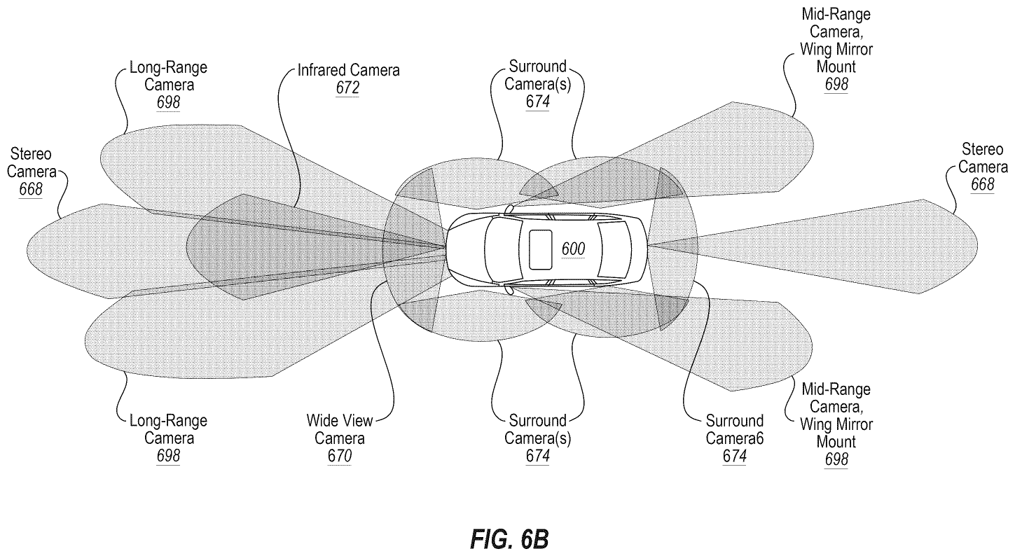

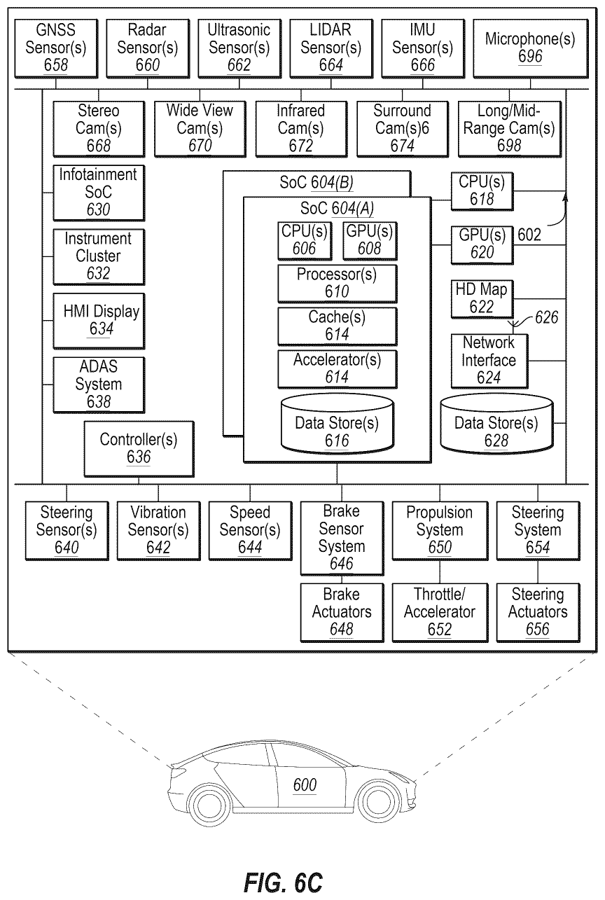

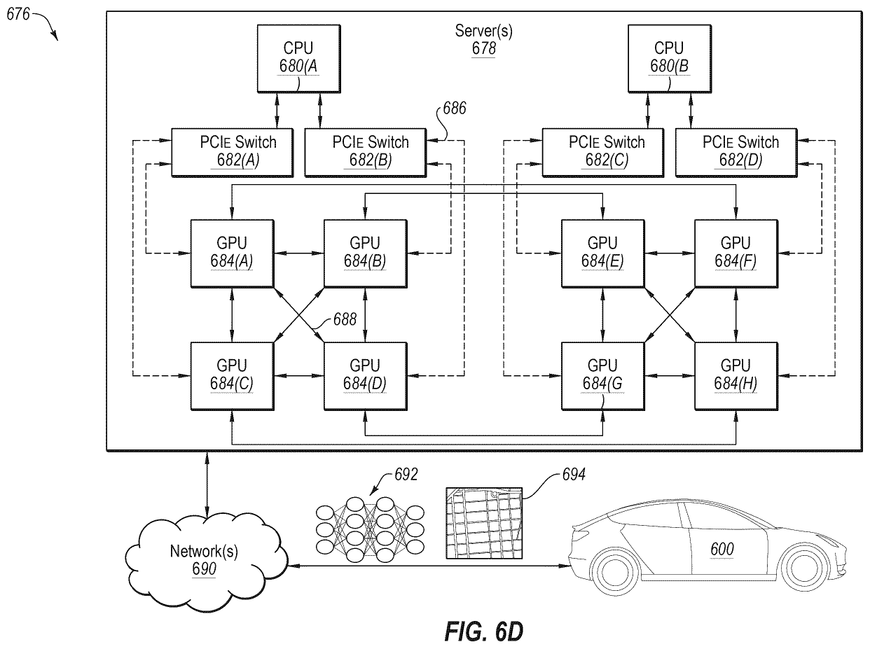

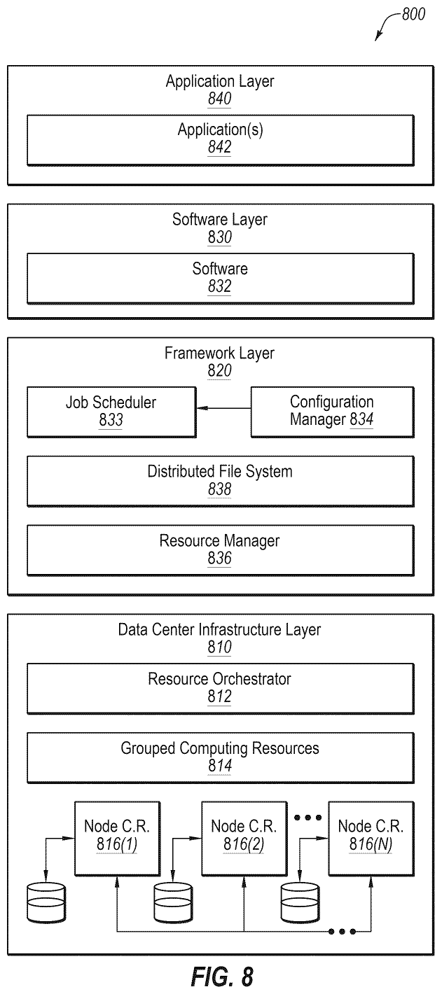

FIG. 5 is a flow diagram illustrating a method 500 for generating output data corresponding to one or more objects included in an area, in accordance with one or more embodiments of the present disclosure. One or more operations of the method 500 may be performed by any suitable system, apparatus, or device such as, for example, the system 100, the system 200 of FIG. 2A, the system 250 of FIG. 2B, the system 280 of FIG. 2C, the neural network 302 of FIG. 3A, the neural network 312 of FIG. 3B, and/or the neural network 322 of FIG. 3C, the autonomous vehicle system(s) described with respect to FIGS. 6A-6D, computing device(s) described with respect to FIG. 7, and/or the data system(s) described with respect to FIG. 8 in the present disclosure.

The method 500 may include one or more blocks. Although illustrated with discrete blocks, the operations associated with one or more of the blocks of the method 500 may be divided into additional blocks, combined into fewer blocks, or eliminated, depending on the particular implementation.

The method 500 may include block 502. At block 502, ultrasonic sensor (USS) data corresponding to an area may be obtained. In some embodiments, the USS data may be obtained using one or more ultrasonic sensors. The USS data may be representative of features and/or objects within the area detected using the ultrasonic sensors. For example, the USS data may correspond to one of the first sensor data 112a, the second sensor data 112b or the third sensor data 112c of FIG. 1 obtained using one of the first set of sensors 102a, the second set of sensors 102b, or the third set of sensors 102c.

At block 504, image data corresponding to the area may be obtained. In some embodiments, one or more image sensors (e.g., cameras) may be used to obtain the image data corresponding to the substantially similar area as the USS data. The image data may be representative of features and/or objects within the area detected using the image sensors. For example, the image data may correspond to one of the first sensor data 112a, the second sensor data 112b or the third sensor data 112c of FIG. 1 obtained using one of the first set of sensors 102a, the second set of sensors 102b, or the third set of sensors 102c.

At block 506, RADAR data corresponding to the area may be obtained using one or more RADAR sensors. The RADAR data may be representative of features and/or objects within the area detected using the RADAR sensors. For example, the RADAR data may correspond to one of the first sensor data 112a, the second sensor data 112b or the third sensor data 112c of FIG. 1 obtained using one of the first set of sensors 102a, the second set of sensors 102b, or the third set of sensors 102c.

In some embodiments, the USS data of block 502, the image data of block 504, and the RADAR data of block 506 may be obtained in parallel. For example, the USS data, the image data, and the RADAR data may be obtained in parallel using the ultrasonic sensors, the image sensors, and the RADAR sensors, respectively. In other embodiments, the USS data, the image data, and the RADAR data may be obtained in any order.

At block 508, output data corresponding to the objects and/or features included in the area may be generated based at least on an aggregation of the USS data, the image data, and the RADAR data using one or more neural networks. For example, the output data may correspond to the map data 150 of FIG. 1, generated using the neural network 140, or the output 320 generated by the neural network 312 of FIG. 3B. In some embodiments, output data may include a height map and/or an occupancy map. The height map and/or the occupancy map may represent the locations of the objects with respect to the machine associated with the sensors.

In some embodiments, the output data may be generated based at least on an input dataset. In some embodiment, the input dataset may be generated based at least on first input data that is generated based at least on the USS data, second input data generated based at least on the image data, and third input data generated based at least on the RADAR data. In some embodiments, the first input data, the second input data, and the third input data may correspond to maps (e.g., height maps and/or occupancy maps) generated based at least on the objects and/or features identified using the corresponding sensor data. For example, the first input data may include a first map, the second input data may include a second map, and the third input data may include a third map.

In some embodiments, the first input data, the second input data, and the third input data may be generated using corresponding sets of processes. For example, the first input data may be generated using the system 250 of FIG. 2B configured to process the USS data. The second input data may be generated using the system 280 of FIG. 2C configured to process the image data. The third input data may be generated using the system 200 of FIG. 2A configured to process the RADAR data. In some embodiments, the first input data, the second input data, and the third input data may be generated using one or more neural networks discussed with respect to FIGS. 3A-3C of the present disclosure.

Additionally, in some embodiments, a fourth map may be generated based at least on the objects and/or features present in the RADAR data, the USS data, and the image data. For example, the neural network may combine the features present in the RADAR data, the USS data, and the image data to generate the fourth map. In some embodiments, the neural network may generate the first map, the second map, the third map, and/or the fourth map simultaneously and/or in parallel. For example, the neural network may include one or more branches corresponding to different types of data. In these and other embodiments, the neural network may aggregate the first map, the second map, the third map, and the fourth map to generate the output data or a combined map. For example, the neural network 312 of FIG. 3B may aggregate the features extracted using the first feature extractor layers, the second feature extractor layers 314b, and the third feature extractor layers 314c to generate the fourth map. In some embodiments, the output data or the combined map may include one or more of an occupancy map (e.g., a map representing regions occupied by features and/or objects), a height map (e.g., a map representing elevation of regions), or a distance map (e.g., a map representing distances between the machine and the objects and/or features).

In these and other embodiments, the objects and/or features in different types of data may be extracted using corresponding feature extractors of the neural network (e.g., feature extractor layers of the neural network). For example, a first feature extractor may perform processing with respect to the USS data to extract a first feature dataset. A second feature extractor may perform processing with respect to the image data to extract a second feature dataset, and a third feature extractor may perform processing with respect to the RADAR data to extract a third feature dataset. In these and other embodiments, the combined map may include a combined feature dataset generated based at least on the first feature dataset, the second feature dataset, and the third feature dataset. In some embodiments, the neural network may generate the combined feature dataset using one or more of the first feature extractor, the second feature extractor, and the third feature extractor. In some embodiments, the first feature extractor, the second feature extractor, and the third feature extractor may be communicatively coupled such that the features extracted using a particular feature extractor may be obtained by another feature extractor. In these and other embodiments, the feature extractor obtaining the features may further process the features. For example, the second feature extractor may obtain the features extracted using the first feature extractor to combine the obtained features with the features extracted by the second feature extractor.

In some embodiments, the third input data (e.g., the RADAR data) may include one or more of one or more first RADAR data sets that respectively correspond to one or more individual RADAR scans, or one or more second RADAR data sets that are respectively aggregated from two or more first RADAR data sets.

At block 510, the machine may be caused to perform one or more operations based at least on the output data. For example, the output data may provide the machine with free spaces in the area that the machine may navigate to and/or areas occupied by objects and/or features such that the machine may avoid such areas to avoid collision. In some embodiments, the output data may represent heights of the identified objects and/or features (e.g., using a height map). In these and other embodiments, the machine may perform operations in the free space above the identified objects and/or features.

Modifications, additions, or omissions may be made to the method 500 without departing from the scope of the present disclosure. For example, the operations of method 500 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

### Example Autonomous Vehicle

FIG. 6A is an illustration of an example autonomous vehicle 600, in accordance with some embodiments of the present disclosure. The autonomous vehicle 600 (alternatively referred to herein as the “vehicle 600”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 600 may be capable of functionality in accordance with one or more of Level 3-Level 5 of the autonomous driving levels. The vehicle 600 may be capable of functionality in accordance with one or more of Level 1-Level 5 of the autonomous driving levels. For example, the vehicle 600 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 600 or other machine, such as being fully autonomous, being highly autonomous, being conditionally autonomous, being partially autonomous, providing assistive autonomy, being semi-autonomous, being primarily autonomous, or other designation.

The vehicle 600 may include components such as a chassis, a vehicle body, wheels (e.g., 2, 4, 6, 8, 18, etc.), tires, axles, and other components of a vehicle. The vehicle 600 may include a propulsion system 650, such as an internal combustion engine, hybrid electric power plant, an all-electric engine, and/or another propulsion system type. The propulsion system 650 may be connected to a drive train of the vehicle 600, which may include a transmission, to enable the propulsion of the vehicle 600. The propulsion system 650 may be controlled in response to receiving signals from the throttle/accelerator 652.

A steering system 654, which may include a steering wheel, may be used to steer the vehicle 600 (e.g., along a desired path or route) when the propulsion system 650 is operating (e.g., when the vehicle is in motion). The steering system 654 may receive signals from a steering actuator 656. The steering wheel may be optional for full automation (Level 5) functionality.

The brake sensor system 646 may be used to operate the vehicle brakes in response to receiving signals from the brake actuators 648 and/or brake sensors.

Controller(s) 636, which may include one or more CPU(s), system on chips (SoCs) 604 (FIG. 6C) and/or GPU(s), may provide signals (e.g., representative of commands) to one or more components and/or systems of the vehicle 600. For example, the controller(s) may send signals to operate the vehicle brakes via one or more brake actuators 648, to operate the steering system 654 via one or more steering actuators 656, and/or to operate the propulsion system 650 via one or more throttle/accelerators 652. The controller(s) 636 may include one or more onboard (e.g., integrated) computing devices (e.g., supercomputers) that process sensor signals, and output operation commands (e.g., signals representing commands) to enable autonomous driving and/or to assist a human driver in driving the vehicle 600. The controller(s) 636 may include a first controller 636 for autonomous driving functions, a second controller 636 for functional safety functions, a third controller 636 for artificial intelligence functionality (e.g., computer vision), a fourth controller 636 for infotainment functionality, a fifth controller 636 for redundancy in emergency conditions, and/or other controllers. In some examples, a single controller 636 may handle two or more of the above functionalities, two or more controllers 636 may handle a single functionality, and/or any combination thereof.

The controller(s) 636 may provide the signals for controlling one or more components and/or systems of the vehicle 600 in response to sensor data received from one or more sensors (e.g., sensor inputs). The sensor data may be received from, for example and without limitation, global navigation satellite systems sensor(s) 658 (e.g., Global Positioning System sensor(s)), RADAR sensor(s) 660, ultrasonic sensor(s) 662, LIDAR sensor(s) 664, inertial measurement unit (IMU) sensor(s) 666 (e.g., accelerometer(s), gyroscope(s), magnetic compass(es), magnetometer(s), etc.), microphone(s) 696, stereo camera(s) 668, wide-view camera(s) 670 (e.g., fisheye cameras), infrared camera(s) 672, surround camera(s) 674 (e.g., 360 degree cameras), long-range and/or mid-range camera(s) 698, speed sensor(s) 644 (e.g., for measuring the speed of the vehicle 600), vibration sensor(s) 642, steering sensor(s) 640, brake sensor(s) 646 (e.g., as part of the brake sensor system 646), and/or other sensor types.

One or more of the controller(s) 636 may receive inputs (e.g., represented by input data) from an instrument cluster 632 of the vehicle 600 and provide outputs (e.g., represented by output data, display data, etc.) via a human-machine interface (HMI) display 634, an audible annunciator, a loudspeaker, and/or via other components of the vehicle 600. The outputs may include information such as vehicle velocity, speed, time, map data (e.g., the HD map 622 of FIG. 6C), location data (e.g., the location of the vehicle 600, such as on a map), direction, location of other vehicles (e.g., an occupancy grid), information about objects and status of objects as perceived by the controller(s) 636, etc. For example, the HMI display 634 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 600 further includes a network interface 624, which may use one or more wireless antenna(s) 626 and/or modem(s) to communicate over one or more networks. For example, the network interface 624 may be capable of communication over LTE, WCDMA, UMTS, GSM, CDMA2000, etc. The wireless antenna(s) 626 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 6B is an example of camera locations and fields of view for the example autonomous vehicle 600 of FIG. 6A, in accordance with some embodiments of the present disclosure. The cameras and respective fields of view are one example embodiment and are not intended to be limiting. For example, additional and/or alternative cameras may be included and/or the cameras may be located at different locations on the vehicle 600.

The camera types for the cameras may include, but are not limited to, digital cameras that may be adapted for use with the components and/or systems of the vehicle 600. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 600 (e.g., front-facing cameras) may be used for surround view, to help identify forward-facing paths and obstacles, as well aid in, with the help of one or more controllers 636 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 670 that may be used to perceive objects coming into view from the periphery (e.g., pedestrians, crossing traffic or bicycles). Although only one wide-view camera is illustrated in FIG. 6B, there may any number of wide-view cameras 670 on the vehicle 600. In addition, long-range camera(s) 698 (e.g., a long-view stereo camera pair) may be used for depth-based object detection, especially for objects for which a neural network has not yet been trained. The long-range camera(s) 698 may also be used for object detection and classification, as well as basic object tracking.

One or more stereo cameras 668 may also be included in a front-facing configuration. The stereo camera(s) 668 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 668 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 668 may be used in addition to, or alternatively from, those described herein.

Cameras with a field of view that include portions of the environment to the side of the vehicle 600 (e.g., side-view cameras) may be used for surround view, providing information used to create and update the occupancy grid, as well as to generate side impact collision warnings. For example, surround camera(s) 674 (e.g., four surround cameras 674 as illustrated in FIG. 6B) may be positioned to on the vehicle 600. The surround camera(s) 674 may include wide-view camera(s) 670, fisheye camera(s), 360-degree camera(s), and/or the like. For example, four fisheye cameras may be positioned on the vehicle's front, rear, and sides. In an alternative arrangement, the vehicle may use three surround camera(s) 674 (e.g., left, right, and rear), and may leverage one or more other camera(s) (e.g., a forward-facing camera) as a fourth surround-view camera.

Cameras with a field of view that include portions of the environment to the rear of the vehicle 600 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 698, stereo camera(s) 668), infrared camera(s) 672, etc.), as described herein.

FIG. 6C is a block diagram of an example system architecture for the example autonomous vehicle 600 of FIG. 6A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 600 in FIG. 6C is illustrated as being connected via bus 602. The bus 602 may include a Controller Area Network (CAN) data interface (alternatively referred to herein as a “CAN bus”). A CAN may be a network inside the vehicle 600 used to aid in control of various features and functionality of the vehicle 600, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 602 is described herein as being a CAN bus, this is not intended to be limiting. For example, in addition to, or alternatively from, the CAN bus, FlexRay and/or Ethernet may be used. Additionally, although a single line is used to represent the bus 602, this is not intended to be limiting. For example, there may be any number of busses 602, which may include one or more CAN busses, one or more FlexRay busses, one or more Ethernet busses, and/or one or more other types of busses using a different protocol. In some examples, two or more busses 602 may be used to perform different functions, and/or may be used for redundancy. For example, a first bus 602 may be used for collision avoidance functionality and a second bus 602 may be used for actuation control. In any example, each bus 602 may communicate with any of the components of the vehicle 600, and two or more busses 602 may communicate with the same components. In some examples, each SoC 604, each controller 636, and/or each computer within the vehicle may have access to the same input data (e.g., inputs from sensors of the vehicle 600), and may be connected to a common bus, such the CAN bus.

The vehicle 600 may include one or more controller(s) 636, such as those described herein with respect to FIG. 6A. The controller(s) 636 may be used for a variety of functions. The controller(s) 636 may be coupled to any of the various other components and systems of the vehicle 600 and may be used for control of the vehicle 600, artificial intelligence of the vehicle 600, infotainment for the vehicle 600, and/or the like.

The vehicle 600 may include a system(s) on a chip (SoC) 604. The SoC 604 may include CPU(s) 606, GPU(s) 608, processor(s) 610, cache(s) 612, accelerator(s) 614, data store(s) 616, and/or other components and features not illustrated. The SoC(s) 604 may be used to control the vehicle 600 in a variety of platforms and systems. For example, the SoC(s) 604 may be combined in a system (e.g., the system of the vehicle 600) with an HD map 622 which may obtain map refreshes and/or updates via a network interface 624 from one or more servers (e.g., server(s) 678 of FIG. 6D).

The CPU(s) 606 may include a CPU cluster or CPU complex (alternatively referred to herein as a “CCPLEX”). The CPU(s) 606 may include multiple cores and/or L2 caches. For example, in some embodiments, the CPU(s) 606 may include eight cores in a coherent multi-processor configuration. In some embodiments, the CPU(s) 606 may include four dual-core clusters where each cluster has a dedicated L2 cache (e.g., a 2 MB L2 cache). The CPU(s) 606 (e.g., the CCPLEX) may be configured to support simultaneous cluster operation enabling any combination of the clusters of the CPU(s) 606 to be active at any given time.

The CPU(s) 606 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 606 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 608 may include an integrated GPU (alternatively referred to herein as an “iGPU”). The GPU(s) 608 may be programmable and may be efficient for parallel workloads. The GPU(s) 608, in some examples, may use an enhanced tensor instruction set. The GPU(s) 608 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 608 may include at least eight streaming microprocessors. The GPU(s) 608 may use compute application programming interface(s) (API(s)). In addition, the GPU(s) 608 may use one or more parallel computing platforms and/or programming models (e.g., NVIDIA's CUDA).

The GPU(s) 608 may be power-optimized for best performance in automotive and embedded use cases. For example, the GPU(s) 608 may be fabricated on a Fin field-effect transistor (FinFET). However, this is not intended to be limiting, and the GPU(s) 608 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 608 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 608 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 608 to access the CPU(s) 606 page tables directly. In such examples, when the GPU(s) 608 memory management unit (MMU) experiences a miss, an address translation request may be transmitted to the CPU(s) 606. In response, the CPU(s) 606 may look in its page tables for the virtual-to-physical mapping for the address and transmits the translation back to the GPU(s) 608. As such, unified memory technology may allow a single unified virtual address space for memory of both the CPU(s) 606 and the GPU(s) 608, thereby simplifying the GPU(s) 608 programming and porting of applications to the GPU(s) 608.

In addition, the GPU(s) 608 may include an access counter that may keep track of the frequency of access of the GPU(s) 608 to memory of other processors. The access counter may help ensure that memory pages are moved to the physical memory of the processor that is accessing the pages most frequently.

The SoC(s) 604 may include any number of cache(s) 612, including those described herein. For example, the cache(s) 612 may include an L3 cache that is available to both the CPU(s) 606 and the GPU(s) 608 (e.g., that is connected to both the CPU(s) 606 and the GPU(s) 608). The cache(s) 612 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 604 may include an arithmetic logic unit(s) (ALU(s)) which may be leveraged in performing processing with respect to any of the variety of tasks or operations of the vehicle 600—such as processing DNNs. In addition, the SoC(s) 604 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 606 and/or GPU(s) 608.

The SoC(s) 604 may include one or more accelerators 614 (e.g., hardware accelerators, software accelerators, or a combination thereof). For example, the SoC(s) 604 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 608 and to off-load some of the tasks of the GPU(s) 608 (e.g., to free up more cycles of the GPU(s) 608 for performing other tasks). As an example, the accelerator(s) 614 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 614 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 608, and by using an inference accelerator, for example, a designer may target either the DLA(s) or the GPU(s) 608 for any function. For example, the designer may focus processing of CNNs and floating point operations on the DLA(s) and leave other functions to the GPU(s) 608 and/or other accelerator(s) 614.

The accelerator(s) 614 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 606. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 614 (e.g., the hardware acceleration cluster) may include a computer vision network on-chip and SRAM, for providing a high-bandwidth, low latency SRAM for the accelerator(s) 614. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 604 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 614 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 666 output that correlates with the vehicle 600 orientation, distance, 3D location estimates of the object obtained from the neural network and/or other sensors (e.g., LIDAR sensor(s) 664 or RADAR sensor(s) 660), among others.

The SoC(s) 604 may include data store(s) 616 (e.g., memory). The data store(s) 616 may be on-chip memory of the SoC(s) 604, which may store neural networks to be executed on the GPU and/or the DLA. In some examples, the data store(s) 616 may be large enough in capacity to store multiple instances of neural networks for redundancy and safety. The data store(s) 616 may comprise L2 or L3 cache(s) 612. Reference to the data store(s) 616 may include reference to the memory associated with the PVA, DLA, and/or other accelerator(s) 614, as described herein.

The SoC(s) 604 may include one or more processor(s) 610 (e.g., embedded processors). The processor(s) 610 may include a boot and power management processor that may be a dedicated processor and subsystem to handle boot power and management functions and related security enforcement. The boot and power management processor may be a part of the SoC(s) 604 boot sequence and may provide runtime power management services. The boot power and management processor may provide clock and voltage programming, assistance in system low power state transitions, management of SoC(s) 604 thermals and temperature sensors, and/or management of the SoC(s) 604 power states. Each temperature sensor may be implemented as a ring-oscillator whose output frequency is proportional to temperature, and the SoC(s) 604 may use the ring-oscillators to detect temperatures of the CPU(s) 606, GPU(s) 608, and/or accelerator(s) 614. If temperatures are determined to exceed a threshold, the boot and power management processor may enter a temperature fault routine and put the SoC(s) 604 into a lower power state and/or put the vehicle 600 into a chauffeur to safe-stop mode (e.g., bring the vehicle 600 to a safe stop).

The processor(s) 610 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 610 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 610 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 610 may further include a real-time camera engine that may include a dedicated processor subsystem for handling real-time camera management.

The processor(s) 610 may further include a high dynamic range signal processor that may include an image signal processor that is a hardware engine that is part of the camera processing pipeline.

The processor(s) 610 may include a video image compositor that may be a processing block (e.g., implemented on a microprocessor) that implements video post-processing functions needed by a video playback application to produce the final image for the player window. The video image compositor may perform lens distortion correction on wide-view camera(s) 670, surround camera(s) 674, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 608 is not required to continuously render new surfaces. Even when the GPU(s) 608 is powered on and active doing 3D rendering, the video image compositor may be used to offload the GPU(s) 608 to improve performance and responsiveness.

The SoC(s) 604 may further include a mobile industry processor interface (MIPI) camera serial interface for receiving video and input from cameras, a high-speed interface, and/or a video input block that may be used for camera and related pixel input functions. The SoC(s) 604 may further include an input/output controller(s) that may be controlled by software and may be used for receiving I/O signals that are uncommitted to a specific role.

The SoC(s) 604 may further include a broad range of peripheral interfaces to enable communication with peripherals, audio codecs, power management, and/or other devices. The SoC(s) 604 may be used to process data from cameras (e.g., connected over Gigabit Multimedia Serial Link and Ethernet), sensors (e.g., LIDAR sensor(s) 664, RADAR sensor(s) 660, etc. that may be connected over Ethernet), data from bus 602 (e.g., speed of vehicle 600, steering wheel position, etc.), data from GNSS sensor(s) 658 (e.g., connected over Ethernet or CAN bus). The SoC(s) 604 may further include dedicated high-performance mass storage controllers that may include their own DMA engines, and that may be used to free the CPU(s) 606 from routine data management tasks.

The SoC(s) 604 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 604 may be faster, more reliable, and even more energy-efficient and space-efficient than conventional systems. For example, the accelerator(s) 614, when combined with the CPU(s) 606, the GPU(s) 608, and the data store(s) 616, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 620) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 608.

In some examples, a CNN for facial recognition and vehicle owner identification may use data from camera sensors to identify the presence of an authorized driver and/or owner of the vehicle 600. The always-on sensor processing engine may be used to unlock the vehicle when the owner approaches the driver door and turn on the lights, and, in security mode, to disable the vehicle when the owner leaves the vehicle. In this way, the SoC(s) 604 provide for security against theft and/or carjacking.

In another example, a CNN for emergency vehicle detection and identification may use data from microphones 696 to detect and identify emergency vehicle sirens. In contrast to conventional systems, that use general classifiers to detect sirens and manually extract features, the SoC(s) 604 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 658. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 662, until the emergency vehicle(s) passes.

The vehicle may include a CPU(s) 618 (e.g., discrete CPU(s), or dCPU(s)), that may be coupled to the SoC(s) 604 via a high-speed interconnect (e.g., PCIe). The CPU(s) 618 may include an X86 processor, for example. The CPU(s) 618 may be used to perform any of a variety of functions, including arbitrating potentially inconsistent results between ADAS sensors and the SoC(s) 604, and/or monitoring the status and health of the controller(s) 636 and/or infotainment SoC 630, for example.

The vehicle 600 may include a GPU(s) 620 (e.g., discrete GPU(s), or dGPU(s)), that may be coupled to the SoC(s) 604 via a high-speed interconnect (e.g., NVIDIA's NVLINK). The GPU(s) 620 may provide additional artificial intelligence functionality, such as by executing redundant and/or different neural networks, and may be used to train and/or update neural networks based on input (e.g., sensor data) from sensors of the vehicle 600.

The vehicle 600 may further include the network interface 624 which may include one or more wireless antennas 626 (e.g., one or more wireless antennas for different communication protocols, such as a cellular antenna, a Bluetooth antenna, etc.). The network interface 624 may be used to enable wireless connectivity over the Internet with the cloud (e.g., with the server(s) 678 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 600 information about vehicles in proximity to the vehicle 600 (e.g., vehicles in front of, on the side of, and/or behind the vehicle 600). This functionality may be part of a cooperative adaptive cruise control functionality of the vehicle 600.

The network interface 624 may include a SoC that provides modulation and demodulation functionality and enables the controller(s) 636 to communicate over wireless networks. The network interface 624 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 600 may further include data store(s) 628, which may include off-chip (e.g., off the SoC(s) 604) storage. The data store(s) 628 may include one or more storage elements including RAM, SRAM, DRAM, VRAM, Flash, hard disks, and/or other components and/or devices that may store at least one bit of data.

The vehicle 600 may further include GNSS sensor(s) 658. The GNSS sensor(s) 658 (e.g., GPS, assisted GPS sensors, differential GPD (DGPS) sensors, etc.), to assist in mapping, perception, occupancy grid generation, and/or path planning functions. Any number of GNSS sensor(s) 658 may be used, including, for example and without limitation, a GPS using a USB connector with an Ethernet to Serial (RS-232) bridge.

The vehicle 600 may further include RADAR sensor(s) 660. The RADAR sensor(s) 660 may be used by the vehicle 600 for long-range vehicle detection, even in darkness and/or severe weather conditions. RADAR functional safety levels may be ASIL B. The RADAR sensor(s) 660 may use the CAN and/or the bus 602 (e.g., to transmit data generated by the RADAR sensor(s) 660) for control and to access object tracking data, with access to Ethernet to access raw data, in some examples. A wide variety of RADAR sensor types may be used. For example, and without limitation, the RADAR sensor(s) 660 may be suitable for front, rear, and side RADAR use. In some example, Pulse Doppler RADAR sensor(s) are used.

The RADAR sensor(s) 660 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250 m range. The RADAR sensor(s) 660 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 600 surrounding at higher speeds with minimal interference from traffic in adjacent lanes. The other two antennae may expand the field of view, making it possible to quickly detect vehicles entering or leaving the vehicle's 600 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 600 may further include ultrasonic sensor(s) 662. The ultrasonic sensor(s) 662, which may be positioned at the front, back, and/or the sides of the vehicle 600, may be used for park assist and/or to create and update an occupancy grid. A wide variety of ultrasonic sensor(s) 662 may be used, and different ultrasonic sensor(s) 662 may be used for different ranges of detection (e.g., 2.5 m, 4 m). The ultrasonic sensor(s) 662 may operate at functional safety levels of ASIL B.

The vehicle 600 may include LIDAR sensor(s) 664. The LIDAR sensor(s) 664 may be used for object and pedestrian detection, emergency braking, collision avoidance, and/or other functions. The LIDAR sensor(s) 664 may be functional safety level ASIL B. In some examples, the vehicle 600 may include multiple LIDAR sensors 664 (e.g., two, four, six, etc.) that may use Ethernet (e.g., to provide data to a Gigabit Ethernet switch).

In some examples, the LIDAR sensor(s) 664 may be capable of providing a list of objects and their distances for a 360-degree field of view. Commercially available LIDAR sensor(s) 664 may have an advertised range of approximately 100 m, with an accuracy of 2 cm-3 cm, and with support for a 100 Mbps Ethernet connection, for example. In some examples, one or more non-protruding LIDAR sensors 664 may be used. In such examples, the LIDAR sensor(s) 664 may be implemented as a small device that may be embedded into the front, rear, sides, and/or corners of the vehicle 600. The LIDAR sensor(s) 664, in such examples, may provide up to a 120-degree horizontal and 35-degree vertical field-of-view, with a 200 m range even for low-reflectivity objects. Front-mounted LIDAR sensor(s) 664 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 600. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 664 may be less susceptible to motion blur, vibration, and/or shock.

The vehicle may further include IMU sensor(s) 666. The IMU sensor(s) 666 may be located at a center of the rear axle of the vehicle 600, in some examples. The IMU sensor(s) 666 may include, for example and without limitation, an accelerometer(s), a magnetometer(s), a gyroscope(s), a magnetic compass(es), and/or other sensor types. In some examples, such as in six-axis applications, the IMU sensor(s) 666 may include accelerometers and gyroscopes, while in nine-axis applications, the IMU sensor(s) 666 may include accelerometers, gyroscopes, and magnetometers.

In some embodiments, the IMU sensor(s) 666 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 666 may enable the vehicle 600 to estimate heading without requiring input from a magnetic sensor by directly observing and correlating the changes in velocity from GPS to the IMU sensor(s) 666. In some examples, the IMU sensor(s) 666 and the GNSS sensor(s) 658 may be combined in a single integrated unit.

The vehicle may include microphone(s) 696 placed in and/or around the vehicle 600. The microphone(s) 696 may be used for emergency vehicle detection and identification, among other things.

The vehicle may further include any number of camera types, including stereo camera(s) 668, wide-view camera(s) 670, infrared camera(s) 672, surround camera(s) 674, long-range and/or mid-range camera(s) 698, and/or other camera types. The cameras may be used to capture image data around an entire periphery of the vehicle 600. The types of cameras used depends on the embodiments and requirements for the vehicle 600, and any combination of camera types may be used to provide the necessary coverage around the vehicle 600. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 6A and FIG. 6B.

The vehicle 600 may further include vibration sensor(s) 642. The vibration sensor(s) 642 may measure vibrations of components of the vehicle, such as the axle(s). For example, changes in vibrations may indicate a change in road surfaces. In another example, when two or more vibration sensors 642 are used, the differences between the vibrations may be used to determine friction or slippage of the road surface (e.g., when the difference in vibration is between a power-driven axle and a freely rotating axle).

The vehicle 600 may include an ADAS system 638. The ADAS system 638 may include a SoC, in some examples. The ADAS system 638 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 660, LIDAR sensor(s) 664, and/or a camera(s). The ACC systems may include longitudinal ACC and/or lateral ACC. Longitudinal ACC monitors and controls the distance to the vehicle immediately ahead of the vehicle 600 and automatically adjust the vehicle speed to maintain a safe distance from vehicles ahead. Lateral ACC performs distance keeping, and advises the vehicle 600 to change lanes when necessary. Lateral ACC is related to other ADAS applications such as LCA and CWS.

CACC uses information from other vehicles that may be received via the network interface 624 and/or the wireless antenna(s) 626 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 600), while the I2V communication concept provides information about traffic further ahead. CACC systems may include either or both I2V and V2V information sources. Given the information of the vehicles ahead of the vehicle 600, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 660, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 660, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 600 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 600 if the vehicle 600 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 600 is backing up. Some RCTW systems include AEB to ensure that the vehicle brakes are applied to avoid a crash. RCTW systems may use one or more rear-facing RADAR sensor(s) 660, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 600, the vehicle 600 itself must, in the case of conflicting results, decide whether to heed the result from a primary computer or a secondary computer (e.g., a first controller 636 or a second controller 636). For example, in some embodiments, the ADAS system 638 may be a backup and/or secondary computer for providing perception information to a backup computer rationality module. The backup computer rationality monitor may run a redundant diverse software on hardware components to detect faults in perception and dynamic driving tasks. Outputs from the ADAS system 638 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 604.

In other examples, ADAS system 638 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 638 may be fed into the primary computer's perception block and/or the primary computer's dynamic driving task block. For example, if the ADAS system 638 indicates a forward crash warning due to an object immediately ahead, the perception block may use this information when identifying objects. In other examples, the secondary computer may have its own neural network that is trained and thus reduces the risk of false positives, as described herein.

The vehicle 600 may further include the infotainment SoC 630 (e.g., an in-vehicle infotainment system (IVI)). Although illustrated and described as an SoC, the infotainment system may not be a SoC, and may include two or more discrete components. The infotainment SoC 630 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 600. For example, the infotainment SoC 630 may include radios, disk players, navigation systems, video players, USB and Bluetooth connectivity, carputers, in-car entertainment, Wi-Fi, steering wheel audio controls, hands-free voice control, a heads-up display (HUD), an HMI display 634, a telematics device, a control panel (e.g., for controlling and/or interacting with various components, features, and/or systems), and/or other components. The infotainment SoC 630 may further be used to provide information (e.g., visual and/or audible) to a user(s) of the vehicle, such as information from the ADAS system 638, autonomous driving information such as planned vehicle maneuvers, trajectories, surrounding environment information (e.g., intersection information, vehicle information, road information, etc.), and/or other information.

The infotainment SoC 630 may include GPU functionality. The infotainment SoC 630 may communicate over the bus 602 (e.g., CAN bus, Ethernet, etc.) with other devices, systems, and/or components of the vehicle 600. In some examples, the infotainment SoC 630 may be coupled to a supervisory MCU such that the GPU of the infotainment system may perform some self-driving functions in the event that the primary controller(s) 636 (e.g., the primary and/or backup computers of the vehicle 600) fail. In such an example, the infotainment SoC 630 may put the vehicle 600 into a chauffeur to safe-stop mode, as described herein.

The vehicle 600 may further include an instrument cluster 632 (e.g., a digital dash, an electronic instrument cluster, a digital instrument panel, etc.). The instrument cluster 632 may include a controller and/or supercomputer (e.g., a discrete controller or supercomputer). The instrument cluster 632 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 630 and the instrument cluster 632. In other words, the instrument cluster 632 may be included as part of the infotainment SoC 630, or vice versa.

FIG. 6D is a system diagram for communication between cloud-based server(s) and the example autonomous vehicle 600 of FIG. 6A, in accordance with some embodiments of the present disclosure. The system 676 may include server(s) 678, network(s) 690, and vehicles, including the vehicle 600. The server(s) 678 may include a plurality of GPUs 684(A)-684(H) (collectively referred to herein as GPUs 684), PCIe switches 682(A)-682(H) (collectively referred to herein as PCIe switches 682), and/or CPUs 680(A)-680(B) (collectively referred to herein as CPUs 680). The GPUs 684, the CPUs 680, and the PCIe switches may be interconnected with high-speed interconnects such as, for example and without limitation, NVLink interfaces 688 developed by NVIDIA and/or PCIe connections 686. In some examples, the GPUs 684 are connected via NVLink and/or NVSwitch SoC and the GPUs 684 and the PCIe switches 682 are connected via PCIe interconnects. Although eight GPUs 684, two CPUs 680, and two PCIe switches are illustrated, this is not intended to be limiting. Depending on the embodiment, each of the server(s) 678 may include any number of GPUs 684, CPUs 680, and/or PCIe switches. For example, the server(s) 678 may each include eight, sixteen, thirty-two, and/or more GPUs 684.

The server(s) 678 may receive, over the network(s) 690 and from the vehicles, image data representative of images showing unexpected or changed road conditions, such as recently commenced road work. The server(s) 678 may transmit, over the network(s) 690 and to the vehicles, neural networks 692, updated neural networks 692, and/or map information 694, including information regarding traffic and road conditions. The updates to the map information 694 may include updates for the HD map 622, such as information regarding construction sites, potholes, detours, flooding, and/or other obstructions. In some examples, the neural networks 692, the updated neural networks 692, and/or the map information 694 may have resulted from new training and/or experiences represented in data received from any number of vehicles in the environment, and/or based on training performed at a datacenter (e.g., using the server(s) 678 and/or other servers).

The server(s) 678 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 690, and/or the machine learning models may be used by the server(s) 678 to remotely monitor the vehicles.

In some examples, the server(s) 678 may receive data from the vehicles and apply the data to up-to-date real-time neural networks for real-time intelligent inferencing. The server(s) 678 may include deep-learning supercomputers and/or dedicated AI computers powered by GPU(s) 684, such as a DGX and DGX Station machines developed by NVIDIA. However, in some examples, the server(s) 678 may include deep learning infrastructure that use only CPU-powered datacenters.

The deep-learning infrastructure of the server(s) 678 may be capable of fast, real-time inferencing, and may use that capability to evaluate and verify the health of the processors, software, and/or associated hardware in the vehicle 600. For example, the deep-learning infrastructure may receive periodic updates from the vehicle 600, such as a sequence of images and/or objects that the vehicle 600 has located in that sequence of images (e.g., via computer vision and/or other machine learning object classification techniques). The deep-learning infrastructure may run its own neural network to identify the objects and compare them with the objects identified by the vehicle 600 and, if the results do not match and the infrastructure concludes that the AI in the vehicle 600 is malfunctioning, the server(s) 678 may transmit a signal to the vehicle 600 instructing a fail-safe computer of the vehicle 600 to assume control, notify the passengers, and complete a safe parking maneuver.

For inferencing, the server(s) 678 may include the GPU(s) 684 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point, connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that enable the computing device 700 to communicate with other computing devices via an electronic communication network, include wired and/or wireless communications. The communication interface 710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may enable the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 700. The computing device 700 may include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that enable detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to enable the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, etc.), and output the data (e.g., as an image, video, sound, etc.).

### Example Data Center

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-816(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 832, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 832. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described in the present disclosure with respect to the data center 800. In at least one embodiment, trained or deployed machine learning models corresponding to one or more neural networks may be used to infer or predict information using resources described in the present disclosure with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described in the present disclosure may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The subject technology of the present invention is illustrated, for example, according to various aspects described below. Various examples of aspects of the subject technology are described as numbered examples (1, 2, 3, etc.) for convenience. These are provided as examples and do not limit the subject technology. The aspects of the various implementations described herein may be omitted, substituted for aspects of other implementations, or combined with aspects of other implementations unless context dictates otherwise. For example, one or more aspects of example 1 below may be omitted, substituted for one or more aspects of another example (e.g., example 2) or examples, or combined with aspects of another example The following is a non-limiting summary of some example implementations presented herein.

Example 1. A method comprising:
obtaining ultrasonic sensor data corresponding to an area;
obtaining image data corresponding to the area;
obtaining RADAR data corresponding to the area;
generating, using one or more neural networks, output data corresponding to one or more objects included in the area based at least on an aggregation of the ultrasonic sensor data, the image data, and the RADAR data; and
causing a machine to perform one or more operations based at least on the output data.

The method of Example 1, wherein the generating of the output data is based at least on the one or more neural networks processing an input data set that is generated based at least on:
first input data that is generated based at least on the ultrasonic sensor data;
second input data that is generated based at least on the image data; and
third input data that is generated based at least on the RADAR data, wherein the third input data includes one or more of:
one or more first RADAR data sets that respectively correspond to one or more individual RADAR scans; or
one or more second RADAR data sets that are respectively aggregated from two or more first RADAR data sets.

The method of Example 1, the first input data corresponds to a first map indicating respective locations in the area of one or more first objects as indicated by the ultrasonic sensor data;
the second input data corresponds to a second map indicating respective locations in the area of one or more second objects as indicated by the image data; and
the third input data corresponds to a third map indicating respective locations in the area of one or more third objects as indicated by the RADAR data.

The method of Example 1, wherein the input data set is generated further based at least on a fourth input data that is generated based at least on the ultrasonic sensor data, the image data, and the RADAR data.

The method of Example 1, wherein the generating of the output data includes:
extracting a first feature data set based at least on first processing performed with respect to the ultrasonic sensor data using a first feature extractor of the one or more neural networks;
extracting a second feature data set based at least on second processing performed with respect to the image data using a second feature extractor of the one or more neural networks;
extracting a third feature data set based at least on third processing performed with respect to the RADAR data using a third feature extractor of the one or more neural networks; and
generating a combined feature data set based at least on fourth feature processing performed with respect to the first feature data set, the second feature data set, and the third feature data set as combined, wherein the fourth feature processing is performed using one or more of the first feature extractor, the second feature extractor, the third feature extractor, or a fourth feature extractor of the one or more neural networks.

The method of Example 1, The method of claim 6, wherein the extracting of the first feature data set, the second feature data set, and the third feature data set is performed in parallel.

The method of Example 1, wherein the output data includes one or more of:
an occupancy map;
a height map; or
a distance map.

Example 2. A system comprising:
one or more processors to cause performance of operations comprising:
generating first input data based at least on ultrasonic sensor data corresponding to an area;
generating second input data based at least on image data corresponding to the area;
generating third input data based at least on RADAR data corresponding to the area; and
processing, using one or more neural networks, an input data set that includes the first input data, the second input data, and the third input data to generate output data corresponding to one or more objects included in the area such that the output data is based at least on an aggregation of the ultrasonic sensor data, the image data, and the RADAR data.

The system of Example 2, wherein the third input data includes one or more of:
one or more first RADAR data sets that respectively correspond to one or more individual RADAR scans; or
one or more second RADAR data sets that are respectively aggregated from two or more first RADAR data sets.

The system of Example 2, wherein:
the first input data corresponds to a first map indicating respective locations in the area of one or more first objects as indicated by the ultrasonic sensor data;
the second input data corresponds to a second map indicating respective locations in the area of one or more second objects as indicated by the image data; and
the third input data corresponds to a third map indicating respective locations in the area of one or more third objects as indicated by the RADAR data.

The system of Example 2, wherein the input data set is generated further based at least on a fourth input data that is generated based at least on the ultrasonic sensor data, the image data, and the RADAR data.

The system of Example 2, wherein the generating of the output data includes:
extracting a first feature data set based at least on first processing performed with respect to the ultrasonic sensor data using a first feature extractor of the one or more neural networks;
extracting a second feature data set based at least on second processing performed with respect to the image data using a second feature extractor of the one or more neural networks;
extracting a third feature data set based at least on third processing performed with respect to the RADAR data using a third feature extractor of the one or more neural networks; and
generating a combined feature data set based at least on fourth feature processing performed with respect to the first feature data set, the second feature data set, and the third feature data set as combined, wherein the fourth feature processing is performed using one or more of the first feature extractor, the second feature extractor, the third feature extractor, or a fourth feature extractor of the one or more neural networks, wherein extracting the first feature data set, the second feature data set, and the third feature data set are performed in parallel.

The system of Example 2, wherein the output data includes one or more of:
an occupancy map;
a height map; or
a distance map.

The system of Example 2, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

Example 3. A system comprising:
processing circuitry to perform operations comprising:
obtaining ultrasonic sensor data corresponding to an area;
obtaining image data corresponding to the area;
obtaining RADAR data corresponding to the area; and
generating, using one or more neural networks, output data corresponding to one or more objects included in the area based at least on an aggregation of the ultrasonic sensor data, the image data, and the RADAR data.

The system of Example 3, wherein the generating of the output data is based at least on the one or more neural networks processing an input data set that is generated based at least on:
first input data that is generated based at least on the ultrasonic sensor data;
second input data that is generated based at least on the image data; and
third input data that is generated based at least on the RADAR data.

What is claimed is:

1. A method comprising:
obtaining ultrasonic data corresponding to an area;
obtaining image data corresponding to the area;
obtaining RADAR data corresponding to the area;
processing, using one or more neural networks, an aggregation of ultrasonic data, image data, and RADAR data to generate output data corresponding to one or more objects located in the area; and
causing a machine to perform one or more operations based at least on the output data.

2. The method of claim 1, wherein the generating of the output data is based at least on the one or more neural networks processing an input data set that is generated based at least on:
first input data that is generated based at least on the ultrasonic data;
second input data that is generated based at least on the image data; and
third input data that is generated based at least on the RADAR data.

3. The method of claim 2, wherein the third input data includes one or more of:
one or more first RADAR data sets that respectively correspond to one or more individual RADAR scans; or
one or more second RADAR data sets that are respectively aggregated from two or more first RADAR data sets.

4. The method of claim 2, wherein:
the first input data corresponds to a first map indicating respective locations in the area of one or more first objects as indicated by the ultrasonic data;
the second input data corresponds to a second map indicating respective locations in the area of one or more second objects as indicated by the image data; and
the third input data corresponds to a third map indicating respective locations in the area of one or more third objects as indicated by the RADAR data.

5. The method of claim 2, wherein the input data set is further generated based at least on fourth input data that is generated based at least on fusing the ultrasonic data, the image data, and the RADAR data.

6. The method of claim 1, wherein the generating of the output data includes:
extracting a first feature data set based at least on first processing performed with respect to the ultrasonic data using a first feature extractor of the one or more neural networks;
extracting a second feature data set based at least on second processing performed with respect to the image data using a second feature extractor of the one or more neural networks;
extracting a third feature data set based at least on third processing performed with respect to the RADAR data using a third feature extractor of the one or more neural networks; and
generating a combined feature data set based at least on fourth feature processing performed with respect to the first feature data set, the second feature data set, and the third feature data set as combined.

7. The method of claim 6, wherein the fourth feature processing is performed using one or more of the first feature extractor, the second feature extractor, the third feature extractor, or a fourth feature extractor of the one or more neural networks.

8. The method of claim 6, wherein the extracting of the first feature data set, the second feature data set, and the third feature data set is performed in parallel.

9. The method of claim 1, wherein the output data includes one or more of:
an occupancy map;
an evidence grid map;
a height map; or
a distance map.

10. A system comprising:
one or more processors to cause performance of operations comprising:
generating first input data based at least on ultrasonic data corresponding to an area;
generating second input data based at least on image data corresponding to the area;
generating third input data based at least on RADAR data corresponding to the area; and
processing, using one or more neural networks, an input data set that includes the first input data, the second input data, and the third input data to generate output data corresponding to one or more objects included in the area such that the output data is based at least on an aggregation of the ultrasonic data, the image data, and the RADAR data.

11. The system of claim 10, wherein the third input data includes one or more of:
one or more first RADAR data sets that respectively correspond to one or more individual RADAR scans; or
one or more second RADAR data sets that are respectively aggregated from two or more first RADAR data sets.

12. The system of claim 10, wherein:
the first input data corresponds to a first map indicating respective locations in the area of one or more first objects as indicated by the ultrasonic data;
the second input data corresponds to a second map indicating respective locations in the area of one or more second objects as indicated by the image data; and
the third input data corresponds to a third map indicating respective locations in the area of one or more third objects as indicated by the RADAR data.

13. The system of claim 10, wherein the input data set is further generated based at least on a fourth input data that is generated based at least on the ultrasonic data, the image data, and the RADAR data.

14. The system of claim 10, wherein the generating of the output data includes:
extracting a first feature data set based at least on first processing performed with respect to the ultrasonic data using a first feature extractor of the one or more neural networks;
extracting a second feature data set based at least on second processing performed with respect to the image data using a second feature extractor of the one or more neural networks;
extracting a third feature data set based at least on third processing performed with respect to the RADAR data using a third feature extractor of the one or more neural networks; and
generating a combined feature data set based at least on fourth feature processing performed with respect to the first feature data set, the second feature data set, and the third feature data set as combined.

15. The system of claim 14, wherein the fourth feature processing is performed using one or more of the first feature extractor, the second feature extractor, the third feature extractor, or a fourth feature extractor of the one or more neural networks.

16. The system of claim 14, wherein extracting the first feature data set, the second feature data set, and the third feature data set are performed in parallel.

17. The system of claim 10, wherein the output data includes one or more of:
an occupancy map;
an evidence grid map;
a height map; or
a distance map.

18. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system for performing one or more generative AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

19. One or more processors comprising:
processing circuitry to cause performance of one or more operations related to an ego-machine based at least on an output of a neural network, the output of the neural network generated based at least on the neural network separately and collectively processing data generated using one or more ultrasonic sensors, one or more RADAR sensors, and one or more image sensors.

20. The one or more processors of claim 19, wherein the separately processing the data includes processing:
first input data that is generated using the one or more ultrasonic sensors;
second input data that is generated using the one or more RADAR sensors; and
third input data that is generated using the one or more image sensors.
